(19) United States
(12) Patent Application Publication
(10) Pub. No.: US 2026/0303817 A1
(43) Pub. Date: Oct. 1, 2026

(54) BILINEAR MODEL FOR VIDEO CODING

(71) Applicant: Alibaba (China) Co., Ltd., Hangzhou (CN)

(72) Inventors: Jie CHEN, Beijing (CN); Ru-ling LIAO, Sunnyvale, CA (US); Yan YE, San Diego, CA (US); Xinwei LI, Beijing (CN)

(21) Appl. No.: 19/559,654

(22) Filed: Mar. 6, 2026

Related U.S. Application Data
(60) Provisional application No. 63/778,615, filed on Mar. 27, 2025.

(51) Int. Cl. H04N 19/137; H04N 19/176

(52) U.S. Cl. CPC H04N 19/137; H04N 19/176

(57) ABSTRACT

A method for encoding video data includes: determining motion vector predictors (MVP) for a target block based on control point motion vectors (CPMV), in which a bilinear model is represented by the CPMVs; determining motion vector differences (MVD), in which each motion vector difference is based on a difference between the corresponding MVP and the CPMV for each control point; and setting the MVDs in a bitstream, in response to the bilinear model being used.

### CROSS-REFERENCE TO RELATED APPLICATIONS

This application claims priority to U.S. Provisional Application No. 63/778,615, titled “BILINEAR MODEL FOR VIDEO CODING,” filed on Mar. 27, 2025, which is hereby incorporated by reference in its entirety.

### TECHNICAL FIELD

The present disclosure generally relates to video processing, and more particularly, to bilinear model for video coding.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

Embodiments of the present disclosure provide methods and apparatuses for bilinear model for video coding.

According to some embodiments, a method for encoding video data includes: determining motion vector predictors (MVP) for a target block based on control point motion vectors (CPMV), in which a bilinear model is represented by the CPMVs; determining motion vector differences (MVD), in which each motion vector difference is based on a difference between the corresponding MVP and the CPMV for each control point; and setting the MVDs in a bitstream, in response to the bilinear model being used.

According to some embodiments, a method for decoding a video bitstream includes: receiving a bitstream including encoded video data for a target block; determining, based on the bitstream, motion vector differences (MVD), in which each motion vector difference is based on a difference between a corresponding motion vector predictor (MVP) and a control point motion vector (CPMV) for each control point of the target block; and in response to a bilinear model being used, reconstructing the target block based on CPMVs derived based on the MVDs, in which the bilinear model is represented by the CPMVs.

According to some embodiments, a method for storing a bitstream includes: receiving a video sequence including one or more pictures; generating a bitstream including coded information associated with the video sequence, by: determining motion vector predictors (MVP) for a target block of the one or more pictures based on control point motion vectors (CPMV), in which a bilinear model is represented by the CPMVs; determining motion vector differences (MVD), in which each motion vector difference is based on a difference between the corresponding MVP and the CPMV for each control point; and coding the MVDs in the bitstream, in response to the bilinear model being used; and storing the bitstream in a non-transitory computer-readable medium.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an exemplary video sequence, according to some embodiments of the present disclosure.

FIG. 2 illustrates a schematic diagram of an exemplary encoder of a video coding system, according to some embodiments of the present disclosure.

FIG. 3 illustrates a block diagram of an exemplary decoder of a video coding system, according to some embodiments of the present disclosure.

FIG. 4 is a block diagram of an exemplary apparatus for encoding or decoding a video, according to some embodiments of the present disclosure.

FIG. 5A and FIG. 5B are two schematic diagrams illustrating control-points-based affine model for blocks, according to some embodiments of the present disclosure.

FIG. 6 is a schematic diagram illustrating motion vector of the center sample of each subblock of a block, according to some embodiments of the present disclosure.

FIG. 7 illustrates control point motion vector inheritance, according to some embodiments of the present disclosure.

FIG. 8A and FIG. 8B illustrate spatial neighbors for deriving affine merge and affine advanced motion vector prediction (AMVP) candidates for deriving inherited candidates and the first type of constructed candidates, according to some embodiments of the present disclosure.

FIG. 9 illustrates locations of candidates position for constructed affine merge mode, according to some embodiments of the present disclosure.

FIG. 10 illustrates a first type of constructed affine merge/AMVP candidates, according to some embodiments of the present disclosure.

FIG. 11A and FIG. 11B are schematic diagrams illustrating a first history parameter table (HPT) and a second history parameter table (HPT), according to some embodiments of the present disclosure.

FIG. 12 illustrates neighboring subblocks being used for regression based affine merge candidate derivation, according to some embodiments of the present disclosure.

FIG. 13 illustrates subblock MV and pixel, according to some embodiments of the present disclosure.

FIG. 14 illustrates an example 3×3 square search pattern, according to some embodiments of the present disclosure.

FIG. 15 illustrates an example 3×3 cross search pattern, according to some embodiments of the present disclosure.

FIG. 16 is a schematic diagram illustrating adaptive search step in an example 3×3 cross search pattern, according to some embodiments of the present disclosure.

FIG. 17 is a schematic diagram illustrating example subblock level pre-interpolation, according to some embodiments of the present disclosure.

FIG. 18 is a schematic diagram illustrating example samples on integer and fractional search points, according to some embodiments of the present disclosure.

FIG. 19A illustrates refining affine parameters by fixing a top-left control point motion vector (CPMV) as a base MV, according to some embodiments of the present disclosure.

FIG. 19B illustrates refining affine parameters by fixing a top-right CPMV as a base MV, according to some embodiments of the present disclosure.

FIG. 19C illustrates refining affine parameters by fixing a bottom-left CPMV as a base MV, according to some embodiments of the present disclosure.

FIG. 20 illustrates an above template and a left template for affine motion compensation, according to some embodiments of the present disclosure.

FIG. 21 illustrates MVs of sub-templates of an affine motion coded block, according to some embodiments of the present disclosure.

FIG. 22 illustrates MVs of sub-templates of an affine motion coded block, according to some embodiments of the present disclosure.

FIG. 23A illustrates an integer template matching (TM) search process, according to some embodiments of the present disclosure.

FIG. 23B illustrates a half-pixel TM search process, according to some embodiments of the present disclosure.

FIG. 24 is a flowchart of a process of an affine merge mode, according to some embodiments of the present disclosure.

FIG. 25 is a schematic diagram illustrating control point motion vector inheritance, according to some embodiments of the present disclosure.

FIG. 26 is a schematic diagram illustrating the first type of constructed affine merge/AMVP candidates, according to some embodiments of the present disclosure.

FIGS. 27A-27D are schematic diagrams illustrating example bilinear parameter refinements, according to some embodiments of the present disclosure.

FIG. 28 illustrates an above template and a left template for a current bilinear mode coded block, according to some embodiments of the present disclosure.

FIG. 29 illustrates MVs of sub-templates of a bilinear mode coded block, according to some embodiments of the present disclosure.

FIG. 30 illustrates MVs of sub-templates of a bilinear mode coded block, according to some embodiments of the present disclosure.

FIG. 31 is a flowchart for an example method for encoding a video bitstream, according to some embodiments of the present disclosure.

FIG. 32 is a flowchart for an example method for decoding a video bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

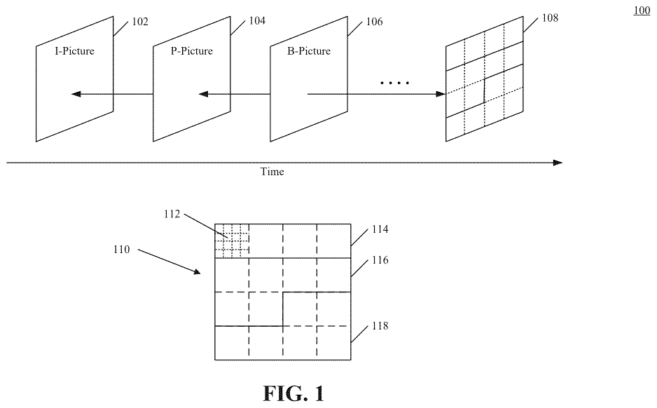

FIG. 1 illustrates structures of an exemplary video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may not be immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples, and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an exemplary structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit, and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vector (MV) difference, etc.) required for corresponding coding mode if inter coded, and quantized residual coefficients are sent.

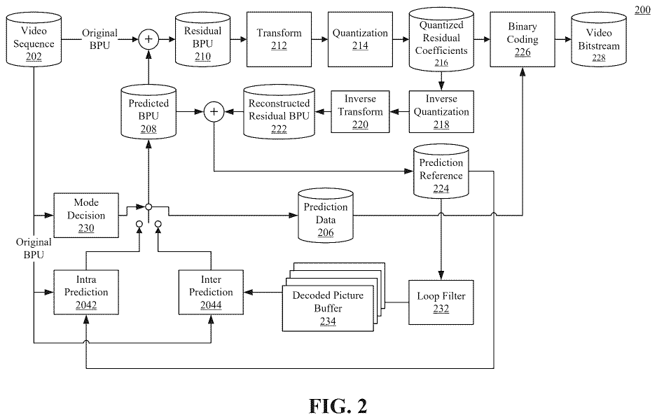

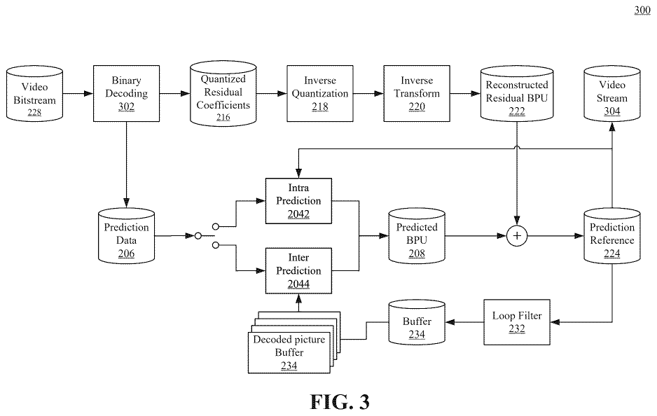

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an exemplary encoder 200 of a video coding system, (e.g., AVS3 or H.26x series), according to some embodiments of the present disclosure. The input video is processed block by block. As discussed above, in some coding standards (e.g., VVC), a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2044, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

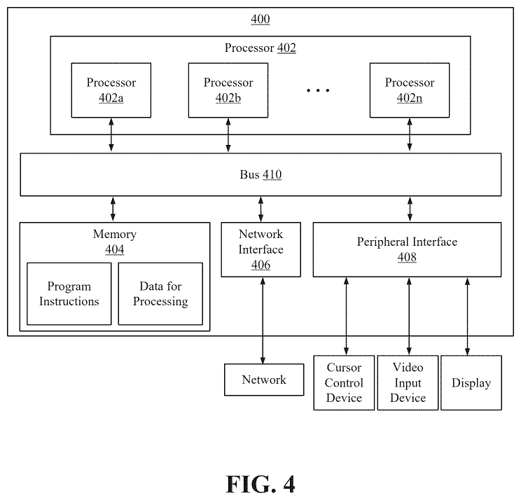

FIG. 4 is a block diagram of an exemplary apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

In some embodiments, there are different skip and direct modes, including normal skip and direct mode, ultimate motion vector expression mode, angular weighted prediction mode, enhanced temporal motion vector prediction mode and affine motion compensation skip/direct mode. The candidate list of motion candidates may include multiple candidates obtained based on different approaches. For example, for normal skip and direct model, a motion candidate list may have 12 candidates, including a temporal motion vector predictor (TMVP) candidate (i.e., a temporal candidate), one or more spatial motion vector predictor (SMVPs) candidates (i.e., spatial candidates), one or more motion vector angular predictor (MVAP) candidates (i.e., subblock based spatial candidates), and one or more history-based motion vector predictor (HMVP) candidates (i.e., history-based candidates). In some embodiments, the encoder or the decoder can first derive and add TMVP and SMVP candidates in the candidate list. After adding TMVP and SMVP candidates, the encoder or the decoder derives and add the MVAP candidates and HMVP candidates. In some embodiments, the number of MVAP candidates added in the candidate list may be varied according to the number of available direction(s) in the MVAP process. For example, the number of MVAP candidate(s) may be between 0 to a maximum number (e.g., 5). After adding MVAP candidate(s), one or more HMVP candidates can be added to the candidate list until the total number of the candidates reaches the target number and the largest number can also be signaled in the bitstream.

In some embodiments, the first candidate is the TMVP derived from the MV of collocated block in a pre-defined reference frame. The pre-defined reference frame is defined as the reference frame with reference index being 0 in the List1 for B frame or List0 for P frame. When the MV of the collocated block is unavailable, a MV predictor (MVP) derived based on the MV of spatial neighboring blocks is used as a block level TMVP.

Next, affine motion compensation is described. In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied.

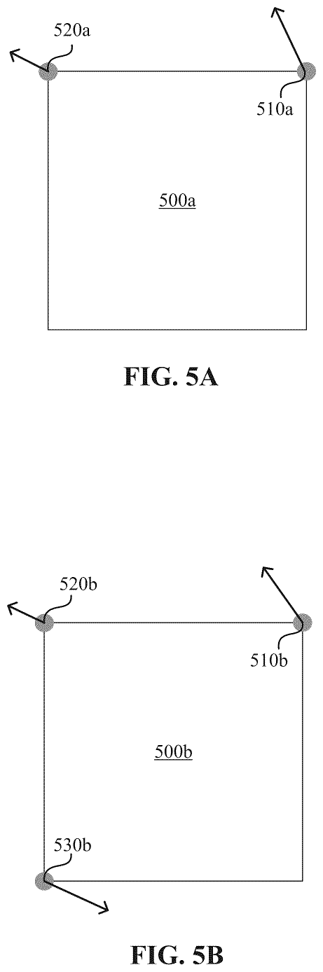

FIG. 5A and FIG. 5B are two schematic diagrams illustrating control-points-based affine model for blocks 500a and 500b, according to some embodiments of the present disclosure. In some embodiments, the control points 510a and 520a in FIG. 5A and the control points 510b, 520b, and 530b in FIG. 5B are respectively set to the corners of the blocks 500a and 500b. As shown FIGS. 5A and 5B, the affine motion field of the block is described by motion information of two control point in 4-parameter affine motion model, or three control point motion vectors in 6-parameter affine motion model. As shown in FIG. 5A, for 4-parameter affine motion model, two control points 510a and 520a are needed. As shown in FIG. 5B, for 6-parameter affine motion model, three control points 510b, 520b, and 530b are needed. To reduce the complexity of the model computation and the bandwidth of the motion compensation, the granularity of the affine motion compensation is on subblock level instead of sample level. In some coding standards, 4×4 or 8×8 luma subblock affine motion compensation is adopted, in which each 4×4 subblock or 8×8 subblock has a motion vector to perform motion compensation.

To derive motion vector of each 8×8 or 4×4 luma subblock, the motion vector of the center position of each subblock is calculated according to two or three control points (CPs), and rounded to 1/16 fraction accuracy.

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 1 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 2 )$$

where (mv₀ₓ, mv_{0y}) is motion vector of the top-left corner control point, (mv₁ₓ, mv_{1y}) is motion vector of the top-right corner control point, and (mv2x, mv2y) is motion vector of the bottom-left corner control point.

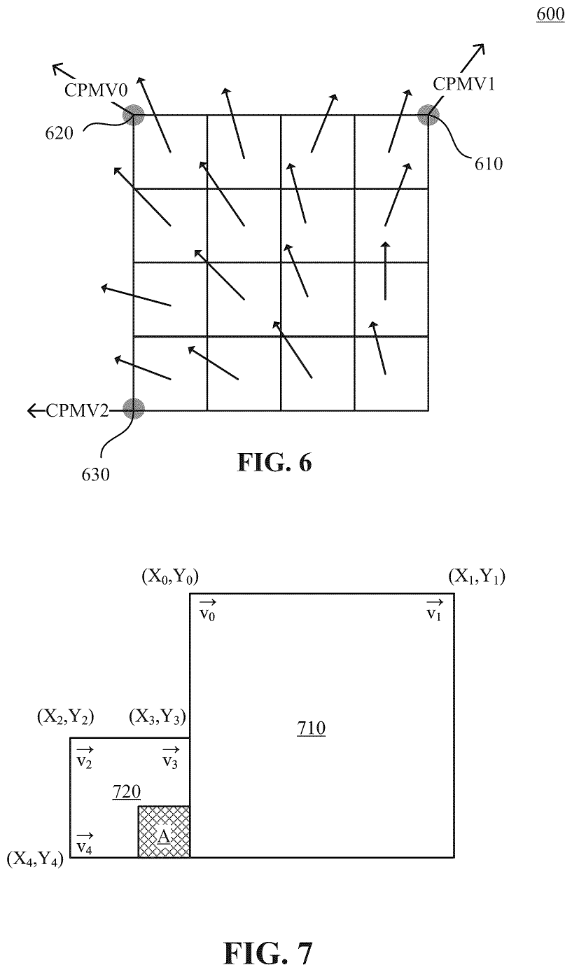

FIG. 6 is a schematic diagram illustrating motion vector of the center sample of each subblock of a block 600, according to some embodiments of the present disclosure. Particularly, FIG. 6 gives example of six parameters affine model, in which motion vector of each subblock can be derived from the motion vectors CPMV0, CPMV1, CPMV2 of three control points 610-630. After derivation of subblock motion vector, the motion compensation is performed to generate the predicted block of the subblock with derived motion vector.

In order to simplify the motion compensation prediction, block based affine transform prediction can be applied. To derive motion vector of each 4×4 luma subblock, the motion vector of the center sample of each subblock, as shown in FIG. 6, is calculated according to above equations, and rounded to 1/16 fraction accuracy.

As done for translational motion inter prediction, there are also two affine motion inter prediction modes: affine merge mode and affine AMVP mode. In some embodiments, affine merge prediction can be used.

Affine merge mode (AF_MERGE) can be applied for coding blocks with both width and height larger than or equal to 8. In this mode, the control point motion vectors (CPMVs) of the current coding block are generated based on the motion information of the spatial neighboring coding blocks. There can be up to 15 affine candidates and an index is signaled to indicate the one to be used for the current coding block.

In some embodiments, the following 8 types of candidates are used to form the affine merge candidate list: (a) inherited candidates from adjacent neighbors; (b) inherited candidates from non-adjacent neighbors; (c) constructed candidates from adjacent neighbors; (d) the second type of constructed affine candidates from non-adjacent neighbors; (e) the first type of constructed affine candidates from non-adjacent neighbors; (f) regression based affine merge candidate; (g) pairwise affine; and (h) zero MVs.

FIG. 7 illustrates control point motion vector inheritance, according to some embodiments of the present disclosure. The inherited affine candidates are derived from affine motion model of the adjacent or non-adjacent blocks. When an adjacent or non-adjacent affine coding block is identified, its control point motion vectors are used to derive the CPMVP candidate in the affine merge list of the current CU 710. As shown in FIG. 7, if the neighboring left bottom block A is coded in affine mode, the motion vectors v₂, v₃ and v₄ of the top left corner, above right corner and left bottom corner of the CU 720 which contains the block A are attained. When block A is coded with 4-parameter affine model, the two CPMVs of the current CU 710 are calculated according to v₂, and v₃. In case that block A is coded with 6-parameter affine model, the three CPMVs of the current CU 710 are calculated according to v₂, v₃ and v₄.

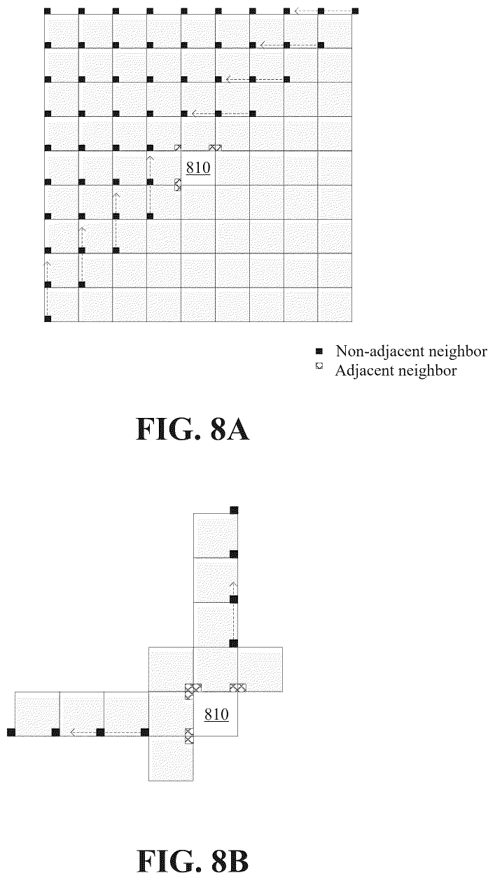

FIG. 8A and FIG. 8B illustrate spatial neighbors for deriving affine merge and affine advanced motion vector prediction (AMVP) candidates, according to some embodiments of the present disclosure. In particular, FIG. 8A illustrates spatial neighbors for deriving inherited candidates, and FIG. 8B illustrates spatial neighbors for deriving the first type of constructed candidates.

For inherited candidates from non-adjacent neighbors in FIG. 8A, the non-adjacent spatial neighbors are checked based on their distances to the current block 810, i.e., from proximal neighbors to distal neighbors. At a specific distance, only the first available neighbor (that is coded with the affine mode) from each side (e.g., the left and above) of the current block 810 is included for inherited candidate derivation. As indicated by the dash arrows in FIG. 8A, the checking orders of the neighbors on the left and above sides are bottom-to-up and right-to-left, respectively.

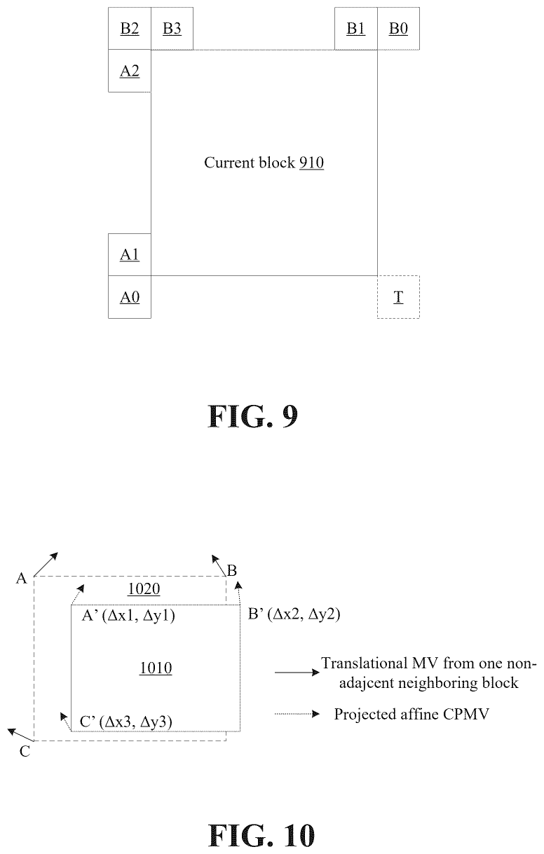

Constructed affine candidates from adjacent neighbors are the candidates constructed by combining the neighbor translational motion information of each control point. FIG. 9 illustrates locations of candidates position for constructed affine merge mode for a current block 910, according to some embodiments of the present disclosure.

The motion information for the control points can be derived from the specified spatial neighbors and temporal neighbor T shown in FIG. 9. CPMVₖ (k=1, 2, 3, 4) represents the k-th control point. For CPMV₁, the B2, B3, A2 blocks are checked and the MV of the first available block is used. For CPMV₂, the B1, B0 blocks are checked and for CPMV₃, the A1, A0 blocks are checked. TMVP can be used as CPMV₄ if it's available.

After MVs of four control points are attained, affine merge candidates are constructed based on those motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

For the first type of constructed candidates, as shown in the FIG. 8B, the positions of one left and above non-adjacent spatial neighbors are firstly determined independently; After that, the location of the top-left neighbor can be determined accordingly which can enclose a rectangular virtual block together with the left and above non-adjacent neighbors.

FIG. 10 illustrates a first type of constructed affine merge/AMVP candidates, according to some embodiments of the present disclosure. As shown in the FIG. 10, the motion information of the three non-adjacent neighbors can be used to form the CPMVs at the top-left (A), top-right (B) and bottom-left (C) of the virtual block 1020, which is finally projected to the current coding block 1010 to generate the corresponding constructed candidates.

For the second type of constructed candidates, the non-translational affine parameters are inherited from the non-adjacent spatial neighbors. Specifically, the second type of affine constructed candidates are generated from the combination of (1) the translational affine parameters of adjacent neighboring 4×4 blocks, and (2) the non-translational affine parameters inherited from the non-adjacent spatial neighbors as defined in FIG. 8A.

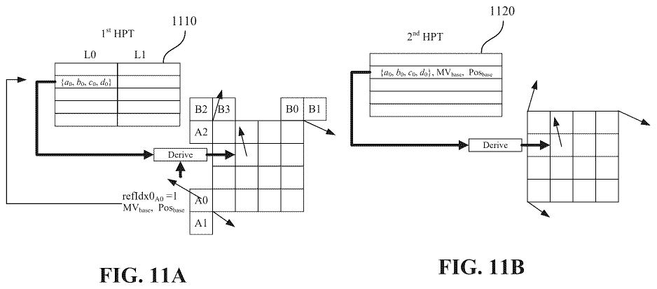

FIG. 11A and FIG. 11B are schematic diagrams illustrating a first history parameter table (HPT) 1110 and a second history parameter table (HPT) 1120, according to some embodiments of the present disclosure. As shown in FIG. 11A, in some embodiments, a first HPT 1110 can be established. An entry of the first HPT 1110 stores a set of affine parameters (a0, b0, c0 and d0), and each affine parameter can be represented by a 16-bit signed integer. Entries in the first HPT 1110 can be categorized by the reference list and the reference index. In some embodiments, five reference indices are supported for each reference list L0 or L1 in the first HPT 1110. In a formular way, the category of the first HPT 1110 (denoted as HPTCat) can be calculated based on the following equation:

$$HPTCat ( refList , RefIdx ) = 5 \times RefList + min ( refIdx , 4 ) \qquad ( 3 )$$

where RefList and RefIdx represent a reference picture list (e.g., L0 or L1) and a reference index, respectively.

For each category, at most seven entries can be stored, resulting in total 70 entries in the first HPT 1110. At the beginning of each CTU row, the number of entries for each category is initialized as zero. After decoding an affine-coded coding block with reference list RefListcur and RefIdxcur, the affine parameters are utilized to update entries in the category HPTCat(RefList_{cur}, RefIdx_{cur}) in a way similar to HMVP table updating. A history-affine-parameter-based candidate (HAPC) is derived from one of the seven neighboring 4×4 blocks denoted as A0, A1, A2, B0, B1, B2 or B3 as in FIG. 11A and a set of affine parameters stored in a corresponding entry in the first HPT 1110. The MV of a neighboring 4×4 block served as the base MV. In a formulating way, the MV of the current block at position (x, y) can be calculated based on the following equations:

$$\{ \begin{matrix}{mv}^{h} ( x , y ) = a ( x - {x}_{b a s e} ) + c ( y - {y}_{b a s e} ) + m {v}_{b a s e}^{h} \\ {mv}^{v} ( x , y ) = b ( x - {x}_{b a s e} ) + d ( y - {y}_{b a s e} ) + m {v}_{b a s e}^{v}\end{matrix} where ( {mv}_{b a s e}^{h} , {mv}_{b a s e}^{v} ) \qquad ( 4 )$$

represents the MV of the neighboring 4×4 block, (x_{base},y_{base}) represents the center position of the neighboring 4×4 block. The position (x, y) can be the top-left, top-right and bottom-left corner of the current block to obtain the corner-position MVs (CPMVs) for the current block, or can be the center of the current block to obtain a regular MV for the current block.

As shown in FIG. 11B, in some embodiments, a second HPT 1120 with base MV information can also be appended. There are nine entries in the second HPT 1120, and an entry includes a base MV (MV_{base}), a reference index and four affine parameters for each reference list, and a base position (Pos_{base}). An additional merge HAPC can be generated from the second HPT 1120 with the base MV information the corresponding affine models stored in an entry. The difference between the first HPT 1110 and the second HPT 1120 is illustrated in FIGS. 11A and 11B. Moreover, pair-wised affine merge candidates can be generated by two affine merge candidates which are history-derived or not history-derived. A pair-wised affine merge candidate can be generated by averaging the CPMVs of existing affine merge candidates in the list.

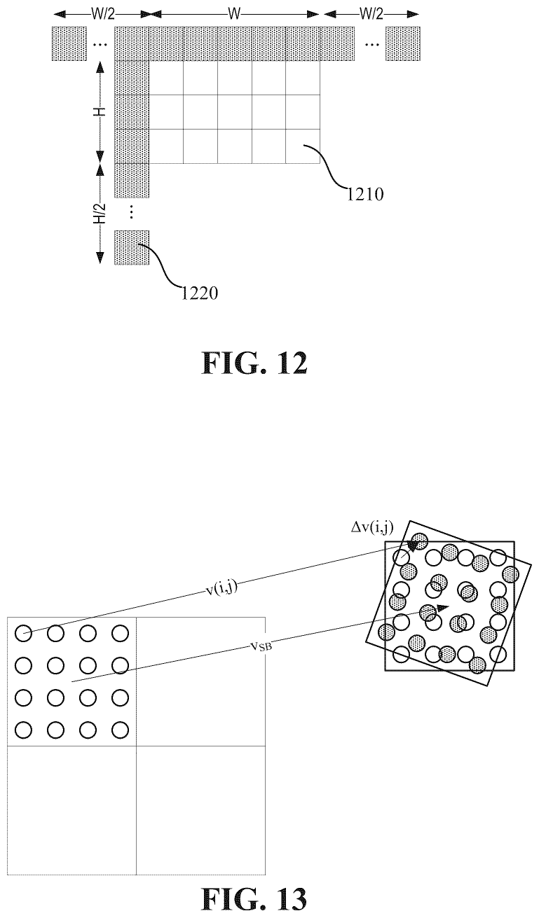

FIG. 12 illustrates neighboring 4×4 subblocks 1220 being used for regression based affine merge candidate derivation, according to some embodiments of the present disclosure. As shown in FIG. 12, 4×4 subblocks 1210 in the current CU are surrounded by neighboring 4×4 subblocks 1220, represented by the grey zone as depicted in FIG. 12. As illustrated in FIG. 12, the subblock motion field from a previous coded affine coding block and the motion vectors from the adjacent subblocks of current coding block are used as the input for the regression process. The predicted CPMVs for current block are derived as output. The regression based affine merge candidates are derived and added to the affine merge list. Subblock motion field from a previously coded affine coding block and motion information from adjacent subblocks of a current coding block are used as the input to the regression process to derive proposed affine candidates. The previously coded affine coding block can be identified from scanning through non-adjacent positions and the affine HMVP table.

Adjacent subblock information of current coding block is fetched from 4×4 subblocks 1220. For each sub-block, given a reference list, the corresponding motion vector and center coordinate of the sub-block may be used. For each affine coding block, up to 2 affine candidates can be derived, including one with adjacent subblock information and one without. All the linear-regression-generated candidates are pruned and collected into one candidate sub-group. TM cost based ARMC process is applied when ARMC is enabled. Afterwards, up to N linear-regression-generated candidates are added to the affine merge list when N affine coding blocks are found. For example, the number of affine candidates for ARMC is 30, the output list size is 15.

In some embodiments, affine candidates derived from temporal collocated pictures are added to the affine merge candidate list. The same sampling pattern from the regular inter merge mode is reused to scan the predefined positions in the collocated pictures to derive the temporal affine candidates. If the scanned position belongs to an affine coded coding block, a new affine candidate is derived by scaling its CPMVs to the current coding block based on its position and block-size in the collocated picture and the derived new affine candidates are inserted into the existing affine merge list and reordered together with the other affine merge candidates by ARMC process.

After inserting all the above candidates into the candidate list, if the list is still not full, zero MVs are inserted to the end of the list.

To reduce the implementation cost of non-adjacent affine candidate, the follows constraint can be imposed. First, the area from where the non-adjacent neighbors come is restricted to be within the current CTU (i.e., no additional storage requirements for line buffer). Second, the storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed. Third, only the top-left and top-right CPMVs are stored (i.e., always using 4-parameter affine model for NA-AFF).

Next, affine advanced motion vector prediction (AMVP) mode is described. In some embodiments, affine advanced motion vector prediction (AMVP) mode can be used. As in conventional AMVP mode, in affine AMVP mode, an AMVP candidate list is constructed with various types of candidates. One of the candidates is selected by the encoder and the index of the selected candidate to the AMVP candidate list is signaled in the bitstream. An AMVP candidate contains two CPMV predictors for a 4-parameter affine model or three CPMV predictors for a 6-parameter affine model. In AMVP mode, the CPMVs of the current coding block is not directly inherited from the AMVP candidate, but determined by the motion estimation in the encoder. And the difference between the CPMVs determined by the motion estimation and the CPMV predictors of the AMVP candidate selected are signaled in bitstream. Here, the difference signaled in the bitstream is called motion vector difference (MVD). For 6-parameter affine model which is defined by the 3 CPMVs, there are 3 MVDs signaled in the bitstream. For the 4-parameter affine model which is defined by 2 CPMVs, there are 2 MVDs signaled in the bitstream. In the decoder side, after decoding in the index of the AMVP candidate the MVDs, the AMVP candidate is determined according to the index. And then, the decoded MVDs are added to the CPMV predictor of the AMVP candidate indicated by the index to get the CPMVs used in the motion compensation of the current block.

There can be up to 2 affine AMVP candidates and an index is signaled to indicate the one to be used for the current CU. Similar with affine merge mode, the following types of candidates may be also used to construct the affine AMVP candidate list: (1) inherited candidates from adjacent neighbors, (2) constructed candidates from adjacent neighbors, (3) translational MVs from adjacent neighbors, (4) translational MVs from temporal neighbors, (5) inherited candidates from non-adjacent neighbors, (6) the second type of constructed affine candidates from non-adjacent neighbors, (7) the first type of constructed affine candidates from non-adjacent neighbors, (8) regression based affine merge candidate, (9) pairwise affine, and (10) zero MVs.

In some embodiments, adaptive affine subblock size and pixel based affine motion compensation are considered. In ECM, the subblock size is adaptively decided. If the motion vector difference of two neighboring luma subblock is smaller than a threshold, luma subblocks will be merged into larger subblocks. If the motion vector difference of the larger subblock is still smaller than the threshold, the larger subblock will continue to be merged until the motion vector difference of the two adjacent subblocks is larger than the threshold or until the subblock is equal to the coding unit. The minimum affine subblock size can be 1×1 for both luma and chroma components, 1×1 subblock size allows pixel based affine MC. When affine subblock width or height is smaller than 4, prediction refinement with optical flow (PROF) is disabled.

After determining the subblock size for affine motion compensation, the motion compensation interpolation filters are applied to generate the prediction of each subblock with derived motion vector. The subblock size of chroma-components is dependent on the size of luma subblock. The MV of a chroma subblock is calculated as the average of the MVs of the top-left and bottom-right luma subblocks in the collocated luma region.

Next, prediction refinement with optical flow for affine mode is described. In some embodiments, prediction refinement with optical flow for affine mode can be used. Subblock based affine motion compensation can save memory access bandwidth and reduce computation complexity compared to pixel-based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as the following four steps.

In step 1, the subblock-based affine motion compensation is performed to generate subblock prediction I(i,j).

In step 2, the spatial gradients gₓ(i,j) and g_{y}(i,j) of the subblock prediction are calculated at each sample location using a 3-tap filter [−1, 0, 1]. The gradient calculation is exactly the same as gradient calculation in BDOF and based on the following equations:

$${g}_{x} ( i , j ) = ( I ( i + 1 , j ) ≫ shift 1 ) - ( I ( i - 1 , j ) ≫ shift 1 ) \qquad ( 5 )$$

$${g}_{y} ( i , j ) = ( I ( i , j + 1 ) ≫ shift 1 ) - ( I ( i , j - 1 ) ≫ shift 1 ) \qquad ( 6 )$$

where shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.

In step 3, the luma prediction refinement is calculated by the following optical flow equation:

$$Δ I ( i , j ) = {g}_{x} ( i , j ) * Δ {v}_{x} ( i , j ) + {g}_{y} ( i , j ) * Δ {v}_{y} ( i , j ) \qquad ( 7 )$$

where the Δv(i,j) is the difference between sample MV computed for sample location (i,j), denoted by v(i,j), and the subblock MV of the subblock to which sample (i,j) belongs, as shown in FIG. 13. FIG. 13 illustrates subblock MV V_{SB} and pixel Δv(i,j), according to some embodiments of the present disclosure. The Δv(i,j) is quantized in the unit of 1/32 luma sample precision.

Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB}, y_{SB}), Δv(x, y) can be derived by the following equations:

$$\{ \begin{matrix}dx ( i , j ) = i - {x}_{S B} \\ dy ( i , j ) = j - {y}_{S B}\end{matrix} \qquad ( 8 )$$

$$\{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix} \qquad ( 9 )$$

In order to keep accuracy, the center of the subblock (x_{SB}, y_{SB}) is calculated as ((WSB−1)/2, (HSB−1)/2), where WSB and HSB are the subblock width and height, respectively. For 4-parameter affine model, the coefficients C, D, E, and F are calculated based on the following equations:

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 10 )$$

For 6-parameter affine model, the coefficients C, D, E, and F are calculated based on the following equations:

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 11 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

In step 4, finally, the luma prediction refinement ΔI(i,j) is added to the subblock prediction I(i, j). The final prediction I′ is generated as the following equation:

$${I}^{′} ( i , j ) = I ( i , j ) + Δ I ( i , j ) \qquad ( 12 )$$

PROF is not applied in two cases for an affine coded CU. First, PROF is not applied when all control point MVs are the same, which indicates the CU only has translational motion. Second, PROF is not applied when the affine motion parameters are greater than a specified limit because the subblock based affine MC is degraded to CU based MC to avoid large memory access bandwidth requirement.

Next, bi-directional optical flow (BDOF) based refinement is described. In some embodiments, BDOF-based refinement for affine subblock can be used. BDOF-based refinement can also be applied on affine coded block with subblock MC when BDOF condition is satisfied.

An affine coded block (e.g., affine regular merge mode, affine BM merge mode, affine AMVP mode) derives MVs for each 4×4 subblock from the affine model. The BDOF process starts with the 4×4 subblocks grouping with identical MVs. The first iteration of BDOF MV refinement is processed in 8×8 subblock grid as in ECM-10.0. When the grouped subblock size is less than 256, the second iteration of BDOF MV refinement is processed in 4×4 subblock grid, and otherwise in 8×8 subblock grid. When the grouped subblock size is 4×N or N×4, the first iteration of BDOF MV refinement is bypassed.

Next, decoder-side motion vector refinement (DMVR) is described. In some embodiments, decoder motion vector refinement (DMVR) for affine merge coded block can be used. In some embodiments, base MV refinement can be used.

In affine model, motion vector at sample location (x, y) can be formulated based on the following equations:

$$\{ \begin{matrix}{mv}_{x} = a x + b y + m {v}_{0 x} \\ {mv}_{y} = c x + d y + m {v}_{0 y}\end{matrix} \qquad ( 13 )$$

where (mvₓ, mv_{y}) is the derived motion vector at sample location (x, y), (mv₀ₓ, mv_{0y}) is called based MV in the model which is the motion vector at sample location (0, 0), and a, b, c, d are the parameters of the affine model which can be derived based on the motion vectors at other two sample locations in the plane. Generally, base MV in the model can be the motion vector at any sample location, not necessarily at location (0, 0). If we choose motion vector at sample location (w, h) as the base MV (denoted as (mv_{wx}, mv_{hy}), then motion vector at sample location (x, y) can be formulated as:

$$\{ \begin{matrix}{mv}_{x} = a ( x - w ) + b ( y - h ) + m {v}_{w x} \\ {mv}_{y} = c ( x - w ) + d ( y - h ) + m {v}_{h y}\end{matrix} \qquad ( 14 )$$

For 4-parameters affine model, b is equal to −c and d is equal to a. Thus, 4-parameter affine model can be formulated as:

$$\{ \begin{matrix}{mv}_{x} = a ( x - w ) - c ( y - h ) + m {v}_{w x} \\ {mv}_{y} = c ( x - w ) + a ( y - h ) + m {v}_{h y}\end{matrix} \qquad ( 15 )$$

Theoretically, all the parameters of affine model, including a, b, c, d and mv_{wx}, mv_{wy} can be refined in DMVR. However, to restrict the complexity, in some embodiments of this disclosure, it is proposed to fix the affine parameter a, b, c and d, and only refine base MV (mv_{wx}, mv_{hy}). That is, the template only has translation motion in the searching process. In each search position, all the sub-templates have the same MV offset compared with the initial MV. Thus, the three CPMVs and the subblock MVs also have a same MV offset after refinement.

Similar to the conventional DMVR, all current search methods of DMVR can be applied. The difference is that when the SAD or SATD cost between two predictors of L0 and L1 is calculated, the motion compensation is performed on subblock level. Accordingly, affine model can be used to derive MV of each subblock, and motion compensation can be performed on subblock level to get the predictor of the whole current affine coded block. In addition, the SAD and the SATD of two predictors (e.g., one from L0 reference picture and other one from L1 reference picture) of the current affine coded block are calculated, from which the cost of the current search point is derived.

In some embodiments, the control point motion vector (CPMV) is refined. That is, the initial set of CPMVs refers to an initial position, then MV offset is added to all the CPMVs to get a surrounding search point obey the following equations:

$${CPMV0\_l0}^{′} = CPMV0\_l0 + MV\_offset \qquad ( 16 )$$

$${CPMV0\_l1}^{′} = CPMV0\_l1 - MV\_offset \qquad ( 17 )$$

$${CPMV1\_l0}^{′} = CPMV1\_l0 + MV\_offset \qquad ( 18 )$$

$${CPMV1\_l1}^{′} = CPMV1\_l1 - MV\_offset \qquad ( 19 )$$

$${CPMV2\_l0}^{′} = CPMV2\_l0 + MV\_offset \qquad ( 20 )$$

$${CPMV2\_l1}^{′} = CPMV2\_l1 - MV\_offset \qquad ( 21 )$$

where CPMVx_l0 is the x-th l0 CPMV and CPMVx_l1 is the x-th l1 CPMV. MV_offset is the motion vector offset for a search point, which is the difference between the initial CPMV and the refined CPMV. After the CPMV is refined, the affine model can be applied to calculate the MV of each subblock, then subblock level motion compensation can be applied to get the predictor of the current block.

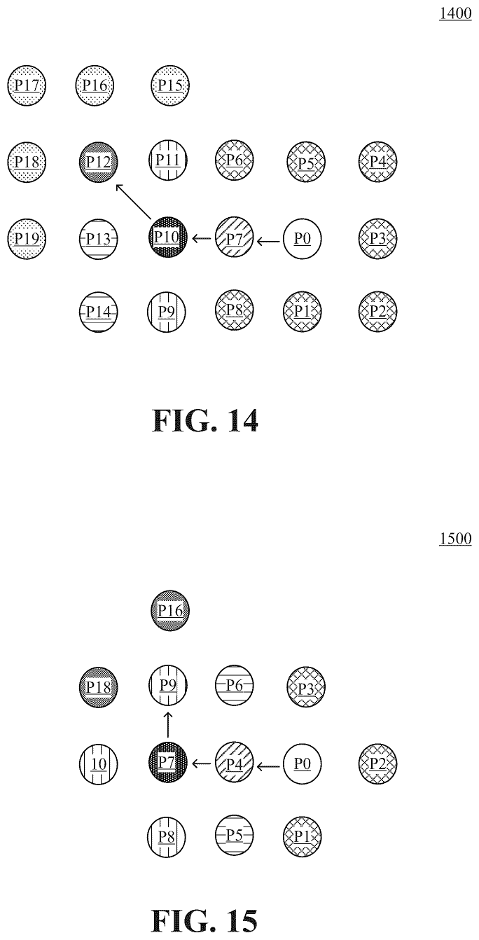

FIG. 14 illustrates an example 3×3 square search pattern 1400, according to some embodiments of the present disclosure. FIG. 15 illustrates an example 3×3 cross search pattern 1500, according to some embodiments of the present disclosure. In some embodiments, conventional search schemes can be applied. For example, as shown in FIG. 14, the 3×3 square search scheme may be applied to get the best integer MV offset. And then the fractional search as well as the fractional error surface estimation method can be applied to derive the best MV offset. As in FIG. 14, point P0 is the position to which the initial MV refers. So, the points P1-P8 surrounding the initial position are searched first and the cost of each position is calculated. If point P7 is with minimum cost, then point P7 is set as search center and points P9-P11 are searched. If cost of point P10 is smaller than the point P7, the search center goes to point P10 and points P12-P14 are searched. If point P12 has the minimum cost among points P6-P14, point P12 is set as new search center. If points P10, P11, P13, and P15-P19 surrounding the point P12 are all larger than point P12, then point 12 is the best position and the search process stops.

For another example, cross search scheme as in FIG. 15 is used to reduce the search number. As in FIG. 15, point P0 is the position to which the initial MV refers and is set as a first search center. Thus, the points P1 to P4 surrounding the initial position are searched first and the cost of each position is calculated.

If point P4 is with minimum cost, then point P4 is set as a second search center and points P5-P7 are searched. Next, if the cost of point P7 is smaller than cost of point P4, P5 and P6, then point P7 is set as a third search center, and points P8 to P10 are searched. Next, when point P9 has the minimum cost among points P7 to P10, point P9 is set as a fourth search center. Next, costs of points P6, P16 and P18 surrounding the point P9 are all found larger than cost of point P9, and then point P9 is the best position and the search process stops.

In some other examples, 3×3 square search and 3×3 cross search can be mixed. Square search scheme can be used in the first k rounds and followed by the cross search to determine the best point, or alternatively, the cross-search scheme can be used first and then the square search is used to determine the best point.

In some other examples, an adaptive search step can be used to accelerate the search process. That is, in the first k rounds of search, the search step is set with a larger number (e.g., 2), and later the search step can be changed to a smaller number (e.g., 1).

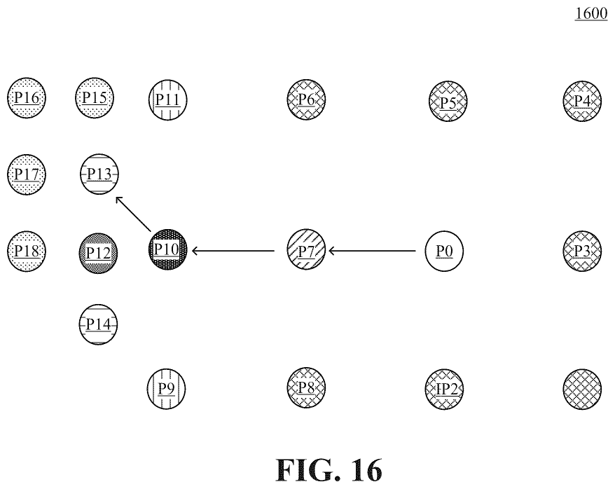

FIG. 16 is a schematic diagram illustrating adaptive search step in an example 3×3 cross search pattern 1600, according to some embodiments of the present disclosure. As shown in FIG. 16, point P0 is the position to which the initial MV refers and is set as a first search center. The points P1 to P8 surrounding the initial position are searched first and the search step is set as 2, so the distance between points P1-P8 and point P0 is 2 pixels, in which a Manhattan distance, not Euclidian distance, is used. Then, in the second search round, as the cost of point P7 is minimum, the search center is point P7, with the search step keeping at 2. Accordingly, search points P9, P10 and P11 are all 2 pixels away from the search center point P7. When point P10 is with the minimum cost, then in the third search round, the search center is point P10 and the search step is set to be 1. Thus, the search points P12 to P14 are 1 pixel away from point P10. Assuming point P13 is with minimum cost, in the fourth search round, the search center is P13 with the search step of 1, and the point P11, P15, P16, P17, and P18 are 1 pixel away from the search center point P13. In various embodiments, the adaptive search step can also be applied in a cross-search pattern or other search patterns.

For each search point, the subblock MV is recalculated with the CPMV of the current search point, and the predictor of the block is derived by performing subblock level motion compensation with the recalculated subblock MV. In addition, the current method may also be applied for calculating the cost of each search point. For example, the cost can be calculated based on the following equation:

$$cost = mvDistanceCost + sadCost \qquad ( 22 )$$

where sadCost is the SAD between l0 predictor and l1 predictor of the current block, and mvDistanceCost is based on the distance between the search point and the initial point (i.e., the difference between the refined CPMV and the initial CPMV).

To control the complexity of refinement, PROF may be or may not be applied before SAD calculation during the search process. If PORF is applied, for each search point, the PROF is applied after getting the predictor to refine the predictor and the SAD is calculated between two PROF refinement predictors. If PORF is not applied, for each search point, SAD can be directly calculated after l0 predictor and l1 predictor are obtained.

In addition, to further reduce the complexity of search process, for each search point, the predictor may be generated with 2-tap bilinear interpolation filter, instead of 8-tap or 12-tap interpolation filter.

In some other embodiments, the refinement is applied on the subblock MV. That is, each subblock MV is derived with the initial CPMV, and then the MV offset is added to the subblock MV to refine the subblock MV which obey the following equations:

$${MV ( s b x )}_{l 0}^{′} = {MV ( s b x )}_{l 0} + MV\_offset \qquad ( 23 )$$

$${MV ( s b x )}_{l 1}^{′} = {MV ( s b x )}_{l 1} - MV\_offset \qquad ( 24 )$$

where MV(sbx)ₗ₀ and MV(sbx)ₗ₁ are the l0 and l1 MV of subblock X, respectively. MV_offset with the current search point is added to all the subblock MVs to get the refined subblock MVs. And then motion compensation is performed on subblock level with each subblock MV to get the two predictors of the whole CU. The SAD or the SATD is calculated between the two predictors and cost of the current search is obtained. The search point with the minimum cost is treated as the best point and the corresponding MV_offset is obtained as the best MV_offset. The search method and the cost calculation method applied in CPMV refinement method can also be applied in the subblock MV refinement method.

FIG. 17 is a schematic diagram illustrating example subblock level pre-interpolation 1700, according to some embodiments of the present disclosure. In some embodiments, to reduce the search complexity, the interpolation of samples of the predictor on each search point within the search window can be done at first and stored at a buffer. Then for each search point, the predictor of each sub-block can be directly fetched from the buffer without interpolation. As shown in the embodiments of FIG. 17, a coding block 1710 is divided into 16 4×4 subblock SB0-SB15 for affine motion compensation. The initial CPMVs are used to calculate initial subblock MV for each subblock. Then for each subblock, a reference subblock (i.e., predictor of the subblock) can be located in the reference picture 1720 by the initial subblock MV. As the refinement is applied on subblock MV, so for each search point, all of the reference subblocks are shifted by the same MV offset. Thus, for each subblock, the samples within each search window can be pre-interpolated as the gray area annotated in FIG. 17. Then for a search point, the sample of the reference block on that search point can be directly fetched from the search window without interpolation. Accordingly, a lot of interpolation can be saved.

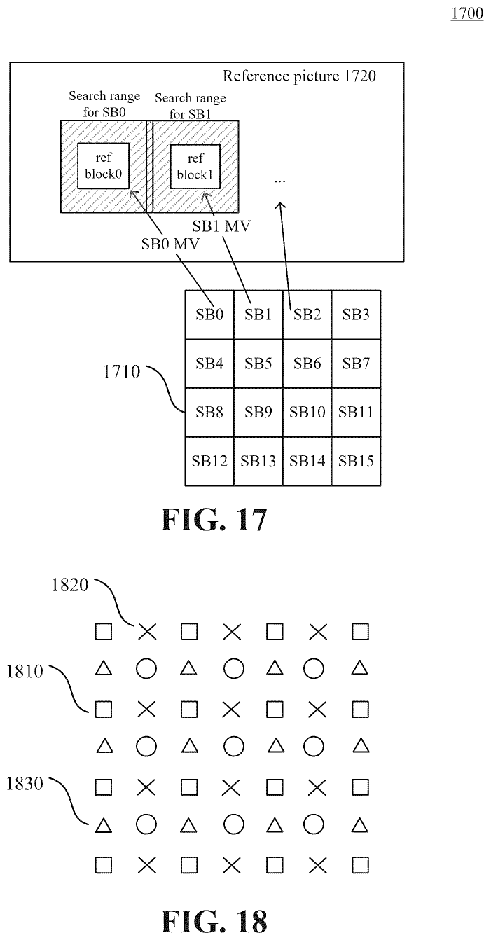

Pre-interpolation could be applied in both integer search process and fractional search process. For integer search process, the samples pre-interpolated can be all one pixel away from each other. In the fractional search process, depending on the phase, the pre-interpolated samples may be stored separately. FIG. 18 is a schematic diagram illustrating example samples on integer and fractional search points, according to some embodiments of the present disclosure. As shown in FIG. 18, the square marks 1810 are the samples for the integer search points which can be all pre-interpolated, the cross marks 1820 represent the samples at ½ pel position in horizontal direction but at integer position in vertical direction, the triangle marks 1830 represent the samples at ½ pel position in vertical direction but at integer position in horizontal direction, and the circle marks represent the samples at ½ pel position in both horizontal and vertical directions. Accordingly, if we only consider ½ pel search process, there could be three different phases of samples and the distance between fractional samples with the same phase is also one pixel. Thus, the fractional samples with the same type can be pre-interpolated together and different phases of samples may be stored separately.

After the CU level base MV refinement, the sub-CU level base MV refinement can also be applied. For example, CU can be divided into multiple sub-CUs which is larger than the subblock (e.g., 16×16 sub-CU) in affine motion compensation. Then for each sub-CUs, the base MV is further refined. That is to say, the subblocks in one sub-CUs share the same base MV offset. Accordingly, the final MV of each subblock can be formulated based on the following equations:

$${MV ( s b x )}_{l 0}^{′} = {MV ( s b x )}_{l 0} + MV\_offset + MV\_offset ( sbCUx ) \qquad ( 25 )$$

$${MV ( s b x )}_{l 1}^{′} = {MV ( s b x )}_{l 1} - MV\_offset - MV\_offset ( sbCUs ) \qquad ( 26 )$$

where MV(sbx)ₗ₀ and MV(sbx)ₗ₁ are the l0 and l1 MV of subblock X, respectively. MV_offset is the offset obtained in the CU level base MV refinement process and MV_offset(sbCUx) is the MV offset obtained in the sub-CU level base MV refinement for the sub-CU in which subblock X is. MV(sbx)ₗ₀ and MV(sbx)ₗ₁ are the final refined MV for the subblock X. Then, the motion compensation is performed with the refined subblock MV in subblock level.

To make a good trade-off between computation complexity and the performance, the search range can be set dependent on PU size or quantization parameters (QP). For example, larger CU may need greater refinement and thus have a larger search range, and smaller CU may have a smaller search range. For another example, larger quantization parameters may bring more distortion, and thus may need a larger search range. Therefore, a larger search range can be used for larger quantization parameters, and a smaller search range can be used for smaller quantization parameters. However, to reduce encoding time, setting a small search range for larger quantization parameters can greatly decrease the number of search points. As a result, in certain situations, it is also possible to choose a smaller search range for larger quantization parameters and a larger search range for smaller quantization parameters.

In some embodiments, a PU size restriction can be imposed to further reduce complexity. That is, the process of affine DMVR can be skipped for some sizes of CUs. For example, affine DMVR is not applied for the CU less than 8×8 or 16×16, or affine DMVR is not applied for the CU larger than 64×64 or 128×128.

To save complexity, an early termination can be applied in DMVR process for affine block. For example, if a search point is checked in the search process of the initial motion vector of a previous candidate in the affine merge candidate list, the search point can be skipped. For another example, if the SAD on a search point is smaller than a predefined threshold, the search process can be terminated and the search point can be used as the best position after refinement.

In some embodiments, to reduce complexity for the encoder and the decoder. A fast algorithm can be used. For example, if a difference of the current affine merge candidate (e.g., the current initial MV) and the previous checked affine merge candidate (e.g., the previous initial MV) is smaller than a threshold, the process of DMVR for the current affine merge candidate can be skipped. That is to say, the current affine merge candidate can be directly used for motion compensation of the current block, without refinement. In some embodiments, the threshold can be dependent on the current block size, and a first threshold for larger blocks may be larger than a second threshold for smaller blocks. For another example, the DMVR is disabled for the affine coded block with size smaller (or greater) than a threshold. That is to say, the small blocks (or the big blocks) do not use DMVR to refine the motion. In various applications, the threshold can be either fixed, or signaled in the bitstream.

In some embodiments, when the DMVR process is applied to affine, the bilateral matching cost is calculated per subblock. Then, the subblock bilateral matching costs and refined subblock MVs are used to determine the overall best refined CPMVs for the affine block. More specifically, the CPMVs are refined according to the following steps.

In the first step, integer-pel bilateral matching is performed for subblocks. The subblock bilateral matching cost is accumulated to determine the best integer-pel MV offset. Then, in the second step, half-pel bilateral matching search is performed, and the best integer MV offset is used as an initial offset to output the best MV offset that minimizes the bilateral matching cost for the same set of the subblocks for the first step. Then, in the third step, linear regression is performed and the refined subblock MVs from the first step is used as an input to output a set of control-point motion vectors. Then, in the fourth step, the bilateral matching cost of the output of the second and the third steps are compared, to select the one with the smallest cost.

Additionally, CPMV search process can also be added in the affine DMVR. For each control point, bilateral matching can be independently performed for a block that is centered by the control-points to derive the refined CPMVs. Then, the refined CPMVs are used to derive the optimized set of CPMVs that minimize the bilateral matching cost of the current block.

In some embodiments, affine non-translation parameter refinement can be used. In addition to the base MV, the parameters of affine model can also be refined. In some embodiments, as affine model denoted in the above equations, offset values offset_a, offset_b, offset_c and offset_d are added to the parameters a, b, c and d to refine these parameters of the affine model. Both the encoder and the decoder can search offset values offset_a, offset_b, offset_c and offset_d to reduce the SAD or SATD between L0 predictor and L1 predictor of the affine coded block. For example, the refinement of the parameters obey the following equations:

$${a\_l0}^{′} = a\_l0 + offset\_a \qquad ( 27 )$$

$${a\_l1}^{′} = a\_l1 - offset\_a \qquad ( 28 )$$

$${b\_l0}^{′} = b\_l0 + offset\_b \qquad ( 29 )$$

$${b\_l1}^{′} = b\_l1 - offset\_b \qquad ( 30 )$$

$${c\_l0}^{′} = c\_l0 + offset\_c \qquad ( 31 )$$

$${c\_l1}^{′} = c\_l1 - offset\_c \qquad ( 32 )$$

$${d\_l0}^{′} = d\_l0 + offset\_d \qquad ( 33 )$$

$${d\_l1}^{′} = d\_l1 - offset\_d \qquad ( 34 )$$

where a_l0, b_l0, c_l0 and d_l0 are the parameters of affine model for reference list 0 and a_l1, b_l1, c_l1 and d_l1 are the parameters of affine model for reference list 1. All 4 non-translation parameters are refined. In the embodiments of the present disclosure, the above refinement can be referred to as 4 parameter refinement.

After the parameter refinement, the subblock MV of reference list 0 and reference list 1 are derived according to the affine model equations with the refined parameters a_l0′, b_l0′, c_l0, d_l0′ and a_l1′, b_l1′, c_l1′, d_l1′, and then subblock MVs are derived and motion compensation is performed on subblock level. The bilateral matching cost (e.g., SAD or SATD) can be calculated either at subblock level or CU level. If the bilateral matching cost is calculated at subblock level, after motion compensation of each subblock, the cost of that subblock is calculated and then after getting the costs of the subblocks, the CU level cost is calculated by summing up all subblock cost. If the bilateral matching cost is calculated at CU level, the motion compensation of all subblocks is performed first to get the L1 and L0 predictors of the whole CU, and then the cost of the whole CU can be calculated. To reduce the calculation complexity, in some embodiments, only a part of subblocks or a part of samples of the CU are considered in the bilateral matching cost calculation. That is, only the differences of a part of subblocks or a part of samples are calculated, so the motion compensation of the subblocks or the samples not considered in the cost calculation can also be skipped.

For 4-parameters affine model, since parameter b is equal to −c, and parameter d is equal to parameter a, the refinement may also obey this constraint. That is to say, the offset value offset_b is equal to −offset_c, and the offset value offset_d is equal to the offset value offset_a. Accordingly, the encoder and the decoder only need to search for the offset values offset_a and offset_b, and then derive the offset values offset_b and offset_d according to the offset values offset_a and offset_b. In the embodiments of the present disclosure, the above refinement can be referred to as 2 parameter refinement.

As a search for 2 parameters is less complicated than a search for 4 parameters, the constraint that the offset value offset_b is equal to −offset_c and the offset value offset_d is equal to offset value offset_a can also be applied in DMVR process of 6-parameter affine model. That is, the refinement obeys the following equations:

$${a\_l0}^{′} = a\_l0 + offset\_a \qquad ( 35 )$$

$${a\_l1}^{′} = a\_l1 - offset\_a \qquad ( 36 )$$

$${b\_l0}^{′} = b\_l0 - offset\_c \qquad ( 37 )$$

$${b\_l1}^{′} = b\_l1 + offset\_c \qquad ( 38 )$$

$${c\_l0}^{′} = c\_l0 + offset\_c \qquad ( 39 )$$

$${c\_l1}^{′} = c\_l1 - offset\_c \qquad ( 40 )$$

$${d\_l0}^{′} = d\_l0 + offset\_a \qquad ( 41 )$$

$${d\_l1}^{′} = d\_l1 - offset\_a \qquad ( 42 )$$

On the other hand, 4 parameter refinement may perform better than 2 parameter refinement, and can also be applied on 4-parameter model. That is, for both 4-parameter and 6-parameter affine model, the same refinement according to equation 27 to equation 34 can be applied.

The MV search method can be applied in the parameter search. For example, for 2 parameter refinement, as shown in FIG. 14 or FIG. 15, the 3×3 square search scheme or 3×3 cross search scheme may be applied to get the desired parameter offset. For 4 parameter refinement, the search is conducted in 4-dimension space. The 3×3×3×3 square search or 3×3×3×3 cross search scheme may be applied to get the desired parameter offset. For 3×3×3×3 square search scheme, for each central position, there are 80 neighboring positions to be searched and for 3×3×3×3 cross search, for each central position, there are 8 neighboring positions to be searched, which is much less than 3×3×3×3 square search. Assuming the parameter offset of the current central position is (offset_a, offset_b, offset_c, offset_d), the eight neighboring positions to be searched in 3×3×3×3 cross search scheme are (offset_a+step_a, offset_b, offset_c, offset_d), (offset_a step_a, offset_b, offset_c, offset_d), (offset_a, offset_b+step_b, offset_c, offset_d), (offset_a, offset_b step_b offset_c, offset_d), (offset_a, offset_b, offset_c+step_c, offset_d), (offset_a, offset_b, offset_c step_c, offset_d), (offset_a, offset_b, offset_c, offset_d+step_d), (offset_a, offset_b, offset_c, offset_d−step_d), where step_a, step_b, step_c and step_d are search steps for parameters a, b, c and d, respectively.

After getting the desired parameter offset, error surface-based offsets estimation could also be applied to further refine the parameter with higher precision. The search step could be set as a fixed value. For example, as the MV precision is 1/16 in ECM, and the basic subblock for affine motion compensation is 4×4, so the search step could be 1/64, so that MV difference of two adjacent subblocks is 1/16 (i.e., 1/64×4), which is the minimum difference for a MV. The search step could be larger than 1/64. A larger search step reduces the search round to save the search time but loses the refinement precision. In some other examples, the search step depends on the CU size. For a CU with the width being w and the height being h, the search step (denoted as step_ac) for parameters a and c and the search step (denoted as step_db) for parameters d and b may satisfy the following equations:

$$w \times step\_ac = T 1 h \times step\_bd = T 2 \qquad ( 43 )$$

where T1 and T2 are two thresholds, which could be 1/16, ⅛, ¼ or other values. The thresholds define the MV difference for the sample in the current coding which is farthest away from the sample with the base MV can be generated during each step of search. In some embodiments, different parameters may have different search steps.

For the cost of each search point, the difference of the parameter offsets could also be considered. That is, the cost, denoted as bilCost, could be a weighted sum of the SAD or SATD between two predictors of the coding block and the parameter offset as the following equation:

$$bilCost = w \times ParameterOffsetCost + sadCost \qquad ( 44 )$$

where w is a weight, sadCost is the SAD/SATD or mean removed SAD/SATD cost of the predictors, and ParameterOffsetCost is a cost dependent on the parameter offset of the refined parameters. When the weight w is equal to 0, only sadCost is considered.

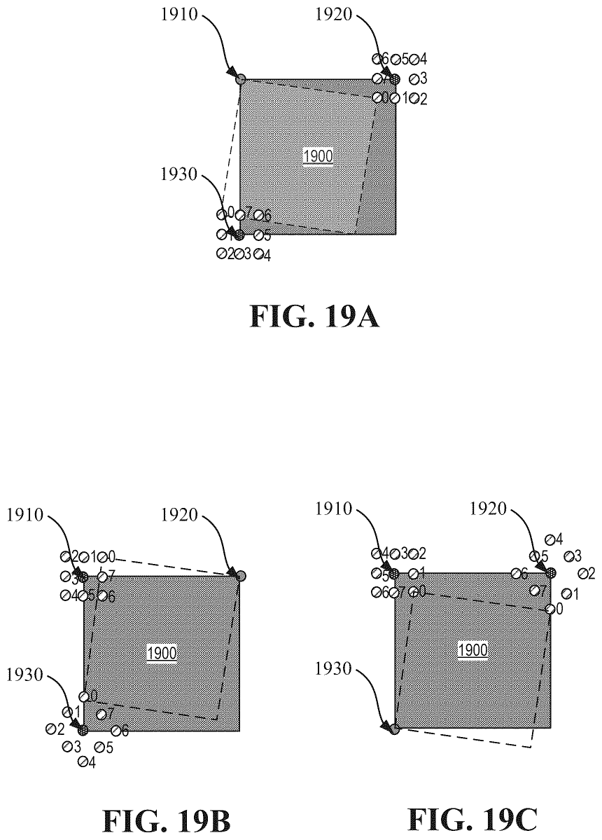

When determining the affine parameters, the base MV could be fixed. Theoretically, MV at any point in the plane can be fixed as the base MV. In some embodiments, the CPMV is fixed as the base MV. FIG. 19A illustrates refining affine parameters by fixing a top-left control point motion vector (CPMV) as a base MV, according to some embodiments of the present disclosure. FIG. 19B illustrates refining affine parameters by fixing a top-right CPMV as a base MV, according to some embodiments of the present disclosure. FIG. 19C illustrates refining affine parameters by fixing a bottom-left CPMV as a base MV, according to some embodiments of the present disclosure.

For example, the top-left CPMV 1910 is fixed, and the affine parameters are refined shown as FIG. 19A. With the change of the parameters, the coding block 1900 rotates and zoom in/out, so the top-right CPMV 1920 and the right-bottom CPMV 1930 are also changed. And then the subblock MV is derived with the refined parameters and the new CPMV, and the motion compensation is performed. FIG. 19B and FIG. 19C give the example of fixing top-right CPMV 1920 and bottom-left CPMV 1930 as base MV, respectively, and refining 4 affine parameters. Similar as FIG. 19A, with the refinement of affine parameters, the coding block 1900 rotates and zoom in/out, so the non-fixed CPMVs are changed. In some embodiments, different CPMVs are fixed as the base MV in turn. That is, the search processing is divided into several steps. In the first step, the top-left CPMV 1910 is fixed as the base MV and the parameters are searched as shown in FIG. 19A. With the best parameters obtained, the top-right CPMV 1920 can be calculated. Then in the second step, as shown in FIG. 19B, the refined top-right CPMV 1920 is fixed and the parameters are refined again. With the best parameters obtained in the second step, the left-bottom CPMV 1930 can be calculated. And then in the third step, the refined left-bottom CPMV 1930 is fixed and the parameters are refined again as shown in FIG. 19C. The steps can be repeated several times. That is, the third step can be followed by the first step with new top-left CPMV 1910 fixed as base MV. And the process can continue until specific conditions are satisfied. For example, the conditions could be but not limited to: (1) a pre-set iteration number; (2) the SAD or SATD between l0 predictor and l1 predictor less than a threshold; (3) the current fixed CPMV is the same or similar as that in last iteration; (4) the offset of the parameters in this round of search is less than a threshold.

In some embodiments, CPMVs are not used as the base MV, but a zero MV can be found in the plane and used as a base MV. First, the following equations can be solved to find the point at (x,y) with zero MV.

$$\{ \begin{matrix}{mv}_{x} = a x + b y + m {v}_{0 x} = 0 \\ {mv}_{y} = c x + d y + m {v}_{0 y} = 0\end{matrix} \qquad ( 45 )$$

Assuming that the solution is (x1, y1), the affine model can be represented as follows with zero base MV:

$$\{ \begin{matrix}\begin{matrix}{mv}_{x} = ax + by + {mv}_{0 x} = a ( x - {x}_{1} ) + b ( y - {y}_{1} ) + \\ {ax}_{1} + {by}_{1} + {mv}_{0 x} = a ( x - {x}_{1} ) + b ( y - {y}_{1} )\end{matrix} \\ \begin{matrix}{mv}_{y} = cx + dy + {mv}_{0 y} = c ( x - {x}_{1} ) + d ( y - {y}_{1} ) + \\ {cx}_{1} + {dy}_{1} + {mv}_{0 x} = c ( x - {x}_{1} ) + d ( y - {y}_{1} )\end{matrix}\end{matrix} \qquad ( 46 )$$

Then, the affine parameters a, b, c and d are searched to find a refined value. All the above refining methods can be applied in embodiments of the present disclosure.

As described above, the affine parameter refinement process can be similar with the base MV refinement process. The search process can be conducted in multiple rounds, and for each round, if the bilateral matching cost of the central position is less than all the neighboring position, the current central position is found as the best position and the search process terminates. Otherwise, the neighboring position with the least bilateral matching cost is set as a new center position and the search goes to the next round. To control the search complexity, a maximum number of search rounds is set at both encoder and decoder side. Accordingly, the search process terminates either when the central position is with the least cost or when the search round number reaches the pre-set maximum number. A larger maximum search round number can give more coding performance gain, but also takes longer encoding and decoding time. In order to make a desired trade-off between the complexity and the performance, the maximum search round may depend on fixed base MV, QP, temporal layer, CU size, etc. For example, as the search process as shown in FIGS. 19A-19C, in the first step, the top-left CPMV 1910 is fixed as the base MV, the maximum search round number is set to a large value as it is the first time parameters are refined, and the larger search round can exploit coding performance. Then, in the second step, the top-right CPMV 1920 is fixed as base MV, the maximum search round number can be set to a smaller value as the parameters are refined in the first step and a small search round number can reduce the coding time. Then in the third step, the bottom-left CPMV 1930 is fixed as base MV, the maximum search round number can be set to a further smaller value to further reduce the coding time. Accordingly, in these embodiments, the maximum search round number is set to a larger value at the beginning, and then changed to a smaller value in the later steps.

In some embodiments, the maximum search round number of the later steps depends on the actual search round number of previous steps. For example, in the first step when the top-left CPMV is set as base MV, the maximum search round number is set to N. During the first step search, the search process terminates in the k-th search round, as the central position has the minimum bilateral matching cost before the search process reaches the N-th round. Then in the second step, the maximum search round number can be set to k/2 (or other values dependent on k and less than an original maximum search round number P for the second round). If in the first step search round, the search process reaches the maximum search round number, then in the second step, the maximum search round number is set to P, which is a value less than N. Similar methods can be applied in the third step. If the actual search round number of the second step reaches the maximum number, the maximum search round number of the third step is set to is L, where L is less than P. If the actual search round number is t before the search process reaches the P-th round, the maximum search round number of the third step is set to t/2. Accordingly, the maximum search round number can be adaptively determined by the previous search process.

In some embodiments, to reduce the complexity, the search neighboring positions of a search round can be reduced adaptively according to the previous search round. For example, in the 3×3×3×3 cross search scheme, there are eight neighboring positions to be searched in each search round. Assuming the current center is (a, b, c, d) and the eight neighboring positions to be checked are pa0=(a+s, b, c, d), pa1=(a−s, b, c, d), pb0=(a, b+s, c, d), pb1=(a, b−s, c, d), pc0=(a, b, c+s, d), pc1=(a, b, c−s, d), pd0=(a, b, c, d+s) and pd1=(a, b, c, d−s), respectively, the bilateral matching cost of eight neighboring positions are denoted as cost_pa0, cost_pa1, cost_pb0, cost_pb1, cost_pc0, cost_pc1, cost_pd0, and cost_pd1. In some embodiments, two costs associated with parameter a, cost_pa0 and cost_pa1, can be compared, and if cost_pa0 is less than cost_pa1, then only positive offset is considered for parameter a in the next round. If cost_pa0 is greater than cost_pa1, then only minus offset is considered for parameter a in the next round. Similarly, two costs associated with parameter b, cost_pb0 and cost_pb1, can be compared, and if cost_pb0 is less than cost_pb1, then only positive offset is considered for parameter b in the next round. If cost_pb0 is greater than cost_pb1, then only minus offset is considered for parameter b in the next round. Similarly, two costs associated with parameter c, cost_pc0 and cost_pc1, can be compared, and if cost_pc0 is less than cost_pc1, then only positive offset is considered for parameter c in the next round. If cost_pc0 is greater than cost_pc1, then only minus offset is considered for parameter c in the next round. Similarly, two costs associated with parameter d, cost_pd0 and cost_pd1, can be compared, and if cost_pd0 is less than cost_pd1, then only positive offset is considered for parameter din the next round. If cost_pd0 is greater than cost_pd1, then only minus offset is considered for parameter din the next round. Assuming for the current search round, cost_pa0 is less than cost_pa1, cost_pb0 is greater than cost_pb1, cost_pc0 is less than cost_pc1 and cost_pd0 is greater than cost_pd1, then in the next round the four neighboring positions to be checked are (a′+s, b′, c′, d′), (a′, b′−s, c′, d′), (a′, b′, c′+s, d′) and (a′, b′, c′, d′−s), where (a′, b′, c′, d′) is the center position of the next round search.

In some embodiments, the minimum bilateral matching cost of the current search round is compared with that of last search round. If the minimum cost reduction is a small amount, the search process terminates. For example, if the cost of last search round is A which means the cost of the current search center is A, the minimum cost of the neighboring positions is B at position posb, where B is less than A. According to search rule, the search goes to the next round with search center posb. However, in these embodiments, if A−B is less than K or B is greater than A×f, the search process terminates, and the posb is selected as the best position is this search step, where K and f are pre-set thresholds. For example, f can be a factor less than 1, such as 0.95, 0.9 or 0.8.

Quantization Parameter (QP) controls the quantization in video coding. With a higher QP, a larger quantization step is used, and thus more distortion is introduced. For higher QP, more search rounds are needed in the refinement and thus the encoding time increases. To reduce the total coding time, in these embodiments, it is proposed to apply a smaller maximum search round number in higher QP than in lower QP. Other methods for reducing complexity may also be used in high QP. For example, the neighboring positions to be searched can be reduced, the search round can be adaptively reduced, or the search process can be early terminated, depending on the previous search process. Accordingly, in these embodiments, different search strategies may be adopted in different QPs.

In some embodiments, an inter-coded frame, like B frame and P frame, may have one or more reference frames. The time distance between the current frame and the reference frame impacts the accuracy of the inter prediction. The time distance between two frames in video coding is usually represented by picture order count (POC) distance. Usually, with a greater POC distance, the inter prediction accuracy is lower, and the motion information accuracy is also lower, and thus it needs more refinement. In some embodiments, the search process depends on the POC distance between the current frame and the reference frame. For hierarchical B frame, the frame with a higher temporal layer has a shorter POC distance to the reference frame and the frame with a lower temporal layer has a greater POC distance to the reference frame. Accordingly, the search process could also depend on the temporal layer of the current frame. For example, the affine parameter refinement can be disabled for the high temporal layer, as the high temporal layer has a short POC distance to the reference frame and may not need refinement. In another example, a small search round can be set or neighboring search positions can be reduced for high temporal layer frame. Also, other methods for reducing the complexity of parameter refinement could be used for the high temporal layer frame. In these embodiments, the parameter refinement process depends on the temporal or the POC distance between the current frame and the reference frame.

In some embodiments, template matching (TM) based refinement for affine coded blocks can be used. In some embodiments, base MV refinement can be used. In some embodiments, the template matching based refinement is applied to affine merge mode to improve the accuracy of the affine motion which is inherited from the previously coded blocks.

To apply the template matching based refinement, the TM affine merge list is derived first. In one example, the TM affine merge list is the same as the regular affine merge list. That is, the same candidates are used for regular affine merge mode and TM affine merge mode. For regular affine merge mode, one of the candidates is selected and indicated in the bitstream. The motion of the selected candidate is used for motion compensation. for TM affine merge mode, the motion of the candidates can be refined by TM and the refined motion of the selected candidate is used for motion compensation.

As TM merge mode, the motion will be refined by TM. So, in another example, a different affine merge candidate list is constructed by considering TM influence. In the TM merge candidate list, the similarity of the candidates is checked. If a candidate to be inserted into the list is similar with the existing candidates in the list, the candidate will not be inserted as the similar candidate may produce the same motion after TM refinement. To check the similarity of the two affine merge candidates, the difference of CPMVs of the affine candidates are calculated and compared with the threshold. Suppose a first affine merge candidate has three CPMVs as CPMV0=(mv0_x, mv0_y), CPMV1=(mv1_x, mv1_y), CPMV2=(mv2_x, mv2_y), and a second merge candidate has three CPMVs as CPMV0′=(mv0_x′, mv0_y′), CPMV1′=(mv1_x′, mv1_y′), CPMV2′=(mv2_x′, mv2_y′). The first affine candidate and the second affine candidate are similar with each other if the following conditions are satisfied:

$$\{ \begin{matrix}\vert mv0\_x - m v {0}_{-} {x}^{′} \vert < TH0\_x \\ \vert mv0\_y - m v {0}_{-} {y}^{′} \vert < TH0\_y \\ \vert mv1\_x - {mv1\_x}^{′} \vert < TH1\_x \\ \vert mv1\_y - {mv1\_y}^{′} \vert < TH1\_y \\ \vert mv2\_x - {mv2\_x}^{′} \vert < TH2\_x \\ \vert mv2\_y - {mv2\_y}^{′} \vert < TH2\_y\end{matrix} \qquad ( 47 )$$

where TH0_x, TH0_y, TH1_x, TH1_y, TH2_x, TH2_y are thresholds which may be dependent on the coding block size. All the types of affine candidate includes inherited candidates from adjacent neighbors and non-adjacent neighbors, constructed candidates from adjacent neighbors, the first type of constructed candidates from non-adjacent neighbors, the second type of constructed candidates from non-adjacent neighbors, regression-based candidates, and pairwise affine candidate.

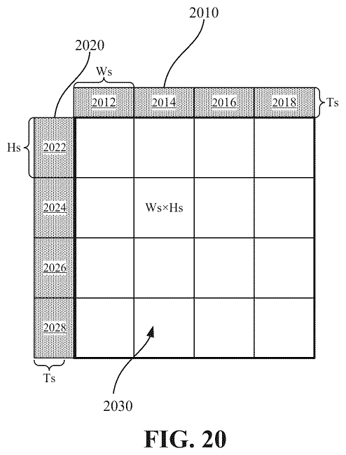

As affine motion compensation is performed at subblock level, template of affine merge candidate also includes several sub-templates. FIG. 20 illustrates an above template 2010 and a left template 2020 for affine motion compensation, according to some embodiments of the present disclosure. As shown in FIG. 20, if the template size used in TM is equal to Ts and the affine merge candidates with subblock size equal to Ws×Hs, the above template 2010 includes several sub-templates 2012, 2014, 2016, and 2018 with the size of Ws×Ts, and the left template 2020 includes several sub-templates 2022, 2024, 2026, and 2028 with the size of Ts×Hs. As shown in FIG. 20, the white region is a current affine motion coded coding block including 16 subblocks 2030 and the dotted area is a template including 4 above sub-templates 2012, 2014, 2016, and 2018 with size of Ws×Ts and 4 left sub-templates 2022, 2024, 2026, and 2028 with size of Ts×Hs. Ts is the size of the template. For example, Ts could be 1, 2, 3 or 4.

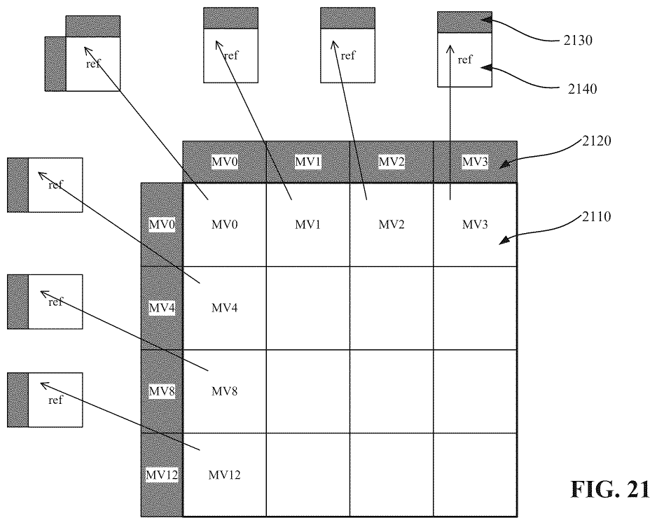

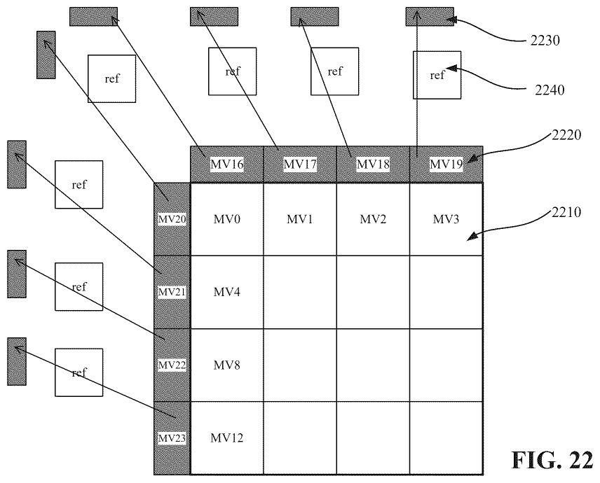

To get the template of the reference block, the MV of each subblock template needs to be derived. In some embodiments, the MV of each sub-template can be borrowed from the boundary subblock. That is, the MV of a sub-template is the same as the MV of the adjacent subblock within the current coding block. FIG. 21 illustrates MVs of sub-templates of an affine motion coded block, according to some embodiments of the present disclosure. As shown in FIG. 21, the white subblocks are the subblocks 2110 of the current coding block and the dotted subblocks are the sub-templates 2120. The MV value (e.g., MV0, MV1, MV2, MV3, MV4, MV8 and MV12) of the boundary subblock 2110 is the same as MV of the corresponding sub-template 2120. Thus, the sub-templates 2130 of reference block are adjacent to the reference subblocks 2140 which are marked as “ref.” In some other embodiments, the MV of sub-template can be derived according to the affine model based on the coordinate of each sub-template. Thus, each sub-template has its own MV which may be different from that of boundary subblock. FIG. 22 illustrates MVs of sub-templates of an affine motion coded block, according to some embodiments of the present disclosure. As shown in FIG. 22, the boundary subblocks 2210 have MV values marked as MV0, MV1, MV2, MV3, MV4, MV8 and MV12, and the sub-templates 2220 have MV values marked as MV16 to MV23. As the sub-template MVs may be different from the boundary subblock MVs, the sub-templates 2230 of the reference block may be separated from the reference blocks 2240.

For an affine model, motion vector at sample location (x, y) can be formulated as

$$\{ \begin{matrix}{mv}_{x} = a x + b y + m {v}_{0 x} \\ {mv}_{y} = c x + d y + m {v}_{0 y}\end{matrix} \qquad ( 48 )$$

where (mvₓ, mv_{y}) is the derived motion vector at sample location (x, y), (mv₀ₓ, mv_{0y}) is called based MV in the model which is the motion vector at sample location (0, 0), and a, b, c, d are the parameters of the affine model which can be derived based on the motion vectors at other two sample locations in the plane. Generally, base MV in the model can be the motion vector at any sample location, not necessarily at location (0, 0). If the motion vector at the sample location (w, h) is chosen as the base MV (denoted as (mv_{wx}, mv_{hy}), then the motion vector at sample location (x, y) can be formulated based on the following equations.

$$\{ \begin{matrix}{mv}_{x} = a ( x - w ) + b ( y - h ) + m {v}_{w x} \\ {mv}_{y} = c ( x - w ) + d ( y - h ) + m {v}_{h y}\end{matrix} \qquad ( 49 )$$

For 4-parameters affine model, parameter b is equal to −c and parameter d is equal to parameter a. Thus, 4-parameter affine model can be formulated based on the following equations.

$$\{ \begin{matrix}{mv}_{x} = a ( x - w ) - c ( y - h ) + m {v}_{w x} \\ {mv}_{y} = c ( x - w ) + a ( y - h ) + m {v}_{h y}\end{matrix} \qquad ( 50 )$$

Theoretically, all the parameters of affine model, including parameters a, b, c, d and the base MV (mv_{wx}, mv_{wy}) can be refined in DMVR. However, to restrict the complexity, in some embodiments of this disclosure, it is proposed to fix the affine parameters a, b, c and d, and only refine base MV (mv_{wx}, mv_{hy}). That is, the template only has translation motion in the searching process. In each search position, all the sub-templates have the same MV offset compared with the initial MV. Thus, the three CPMVs and the subblock MVs also have the same MV offset after refinement. If the three initial CPMVs are denoted as CPMV0, CPMV1 and CPMV2, a subblock MV before refinement is denoted as sbMV, and the three refined CPMVs are denoted as CPMV0′, CPMV1′ and CPMV2′, their relations can be expressed in the following equations:

$$\{ \begin{matrix}{CPMV}^{′} = CPMV 0 + M {V}_{offset} \\ C P M V {1}^{′} = C P M V 1 + M {V}_{offset} \\ CPMV {2}^{′} = CPMV 2 + M {V}_{offset}\end{matrix} \qquad ( 51 )$$

$${sbMV}^{′} = {sbMV}^{′} + MV\_offset \qquad ( 52 )$$

where MV_{offset} is the MV refinement in the TM refinement process (i.e., an MV offset producing the best TM cost).

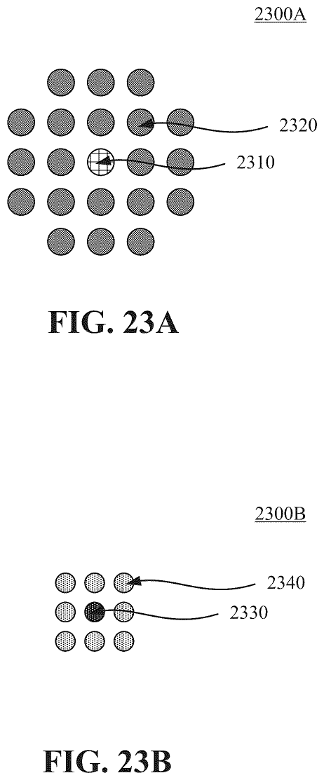

All the search patterns, including cross search, 8-position diamond search, 16-position diamond search pattern can be used. FIG. 23A illustrates an integer template matching (TM) search process 2300A, according to some embodiments of the present disclosure. For example, to reduce the search complexity, in the integer TM search process, only the 20 positions 2320 around the initial position 2310 are searched in FIG. 23A. The position with the minimum TM cost is obtained as the best position in the integer search and it is set as the initial position in the following fractional search process. FIG. 23B illustrates a half-pixel TM search process 2300B, according to some embodiments of the present disclosure. In some embodiments, to reduce the complexity, the 8 half-pixel positions 2340 around the best integer position 2330 are searched in the fractional search process, where the best integer position 2330 is obtained in the integer search process. The position with the minimum TM cost is obtained as the best position in the fractional search and output as the optimal position, and the corresponding MV is referred as the refined MV.

The affine TM refinement can also be applied together with affine DMVR on an affine coded block. In that case, TM refinement process can be performed before DMVR, or can be performed after base MV refinement of affine DMVR but before affine model parameter refinement of affine DMVR, or after affine DMVR.

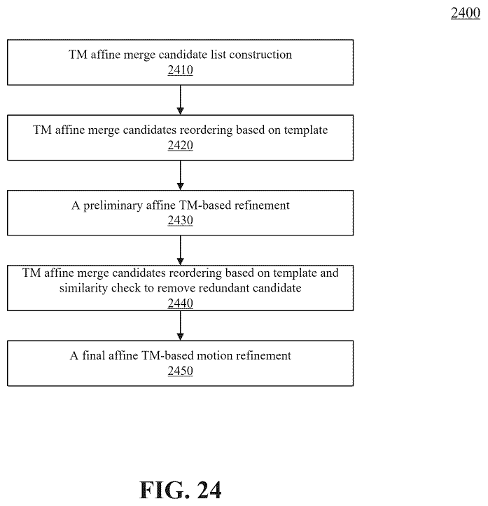

Template-based reordering of merge candidate can also be performed to TM merge candidate. For example, after TM affine merge candidate list construction, the candidates are reordered based on the template. And then the TM refinement is applied on the candidates in the lists, and after TM refinement, another template-based reordering and candidate similarity check can be performed to remove the redundant candidate. A second TM refinement can be applied after then. FIG. 24 is a flowchart of a process 2400 of an affine merge mode, according to some embodiments of the present disclosure. FIG. 24 gives a processing order example for affine merge mode. As shown in FIG. 24, process 2400 includes steps 2410-2450. In step 2410, a TM affine merge candidate list is constructed. In step 2420, the TM affine merge candidates are reordered based on the template. In step 2430, a preliminary affine TM-based refinement is performed. In step 2440, TM affine merge candidates are reordered based on the template and similarity check to remove redundant candidate. In step 2450, a final affine TM-based motion refinement is performed.

In some embodiments, affine non-translation parameter refinement can be used. In some embodiments, to further improve the affine model accuracy, the non-translation parameters are also refined in TM refinement. one way to refine the non-translation parameters is to add offsets to the initial parameters to get refined parameters, and then derive CPMVs, subblock MVs or sub-template MVs from the refined non-translation parameters. The template matching cost is obtained by calculating the difference of the template of the current block and the template of the reference block which are fetched according to sub-template MVs.

In some embodiments, affine non-translation parameter search is performed. For affine model:

$$\{ \begin{matrix}{mv}_{x} = a ( x - w ) + b ( y - h ) + m {v}_{w x} \\ {mv}_{y} = c ( x - w ) + d ( y - h ) + m {v}_{h y}\end{matrix} \qquad ( 53 )$$

the non-translation parameter a, b, c and d are searched in the parameter space. For a search position with parameter values equal to a′, b′, c′ and d′, it can be expressed as:

$$\{ \begin{matrix}{a}^{′} = a + offset\_a \\ {b}^{′} = b + offset\_b \\ {c}^{′} = c + offset\_c \\ {d}^{′} = c + offset\_d\end{matrix} \qquad ( 54 )$$

where offset_a, offset_b, offset_c and offset_d are the parameter offsets searched in the TM refinement process. After getting values of a′, b′, c′, d′, the subblock MVs and sub-template MVs can be derived according to the affine model with a′, b′, c′, d′. And the TM cost can be calculated as the difference between the template of reference block and the template of the current block. By comparing the TM costs corresponding to different values of offset_a, offset_b, offset_c and offset_d, the best non-translation parameter a′, b′, c′, d′ can be obtained as the refined non-translation parameters and the corresponding CPMVs can be calculated as the refined CPMVs.

To reduce the search complexity, the 2-parameter search can be applied. That is, offset_b is constrained to be equal to −offset_c and offset_d is constrained to be equal to offset_a. So, the encoder and the decoder only need to search for offset_a and offset_b, and derive offset_b and offset_d according to offset_a and offset_b. It is called 2 parameter refinement in this disclosure.

The MV search method can be applied in parameter search. For example, for 2 parameter refinement, as shown above in FIG. 14 and FIG. 15, the 3×3 square search or 3×3 cross search scheme may be applied to get the best parameter offset. For 4 parameter refinement, the search is conducted in 4-dimension space. The 3×3×3×3 square search or 3×3×3×3 cross search scheme may be applied to get the best parameter offset. For 3×3×3×3 square search scheme, for each central position, there are 80 neighboring positions to be searched and for 3×3×3×3 cross search, for each central position, there are 8 neighboring positions to be searched which is much less than 3×3×3×3 square search. Suppose the parameter offset of the current central position is (offset_a, offset_b, offset_c, offset_d), the eight neighboring positions to be searched in 3×3×3×3 cross search scheme are (offset_a+step_a, offset_b, offset_c, offset_d), (offset_a−step_a, offset_b, offset_c, offset_d), (offset_a, offset_b+step_b, offset_c, offset_d), (offset_a, offset_b, −step_b offset_c, offset_d), (offset_a, offset_b, offset_c+step_c, offset_d), (offset_a, offset_b, offset_c−step_c, offset_d), (offset_a, offset_b, offset_c, offset_d+step_d), (offset_a, offset_b, offset_c, offset_d−step_d), where step_a, step_b, step_c and step_d are search step for parameter a, b, c and d, respectively. After getting the best parameter offset, error surface-based offsets estimation could also be applied to further refine the parameter with higher precision. The search step could be step as a fixed value. For example, as the MV precision is 1/16 in ECM, and the basic subblock for affine motion compensation is 4×4, the search step could be 1/64 such that the MV difference of two adjacent subblocks is 1/64*4= 1/16 which is the minimum difference for a MV. The search step could be larger than 1/64. A larger search step reduces the search round to save the search time but loses the refinement precision. In another example, the search step is dependent on the CU size. For a CU with the width being w and the height being h, the search step (denoted as step_ac) for parameters a and c and the search step (denoted as step_db) for parameters d and b may satisfy the following equations:

$$w \times step\_ac = T 1 h \times step\_bd = T 2 \qquad ( 55 )$$

wherein T1 and T2 are two thresholds, which could be 1/16, ⅛, ¼ or other values. This threshold defines the MV difference for the sample in the current coding which is farthest away from the sample with the base MV can be generated during each step of search. Please note that in this example, different parameters have different search steps.

For the cost of each search point, the difference of the parameter offsets could also be considered. That is, the cost, denoted as TMCost, could be a weighted sum of the SAD or SATD between the template of the reference block and the template of the current block as the following equation:

$$TMCost = w \times ParameterOffsetCost + sadCost \qquad ( 56 )$$

where w is a weight, sadCost is the SAD/SATD or mean removed SAD/SATD cost of the templates and ParameterOffsetCost is a cost dependent on the parameter offset of the refined parameters. When the weight w is equal to 0, only sadCost is considered.

When determining the affine parameters, the base MV could be fixed, as discussed above in the embodiments of FIGS. 19A-19C and thus detailed discussions are not repeated herein for the sake of brevity.

In some embodiments, similar to the minimum bilateral matching cost, the minimum template matching cost of the current search round can also be compared with that of last search round. If the minimum cost reduction is a small amount, the search process terminates. Detailed explanations have been discussed in the above embodiments and thus are not repeated herein for the sake of brevity.

As discussed in the above embodiments, Quantization Parameter (QP) controls the quantization in video coding. Accordingly in these embodiments, different search strategies may be adopted in different QPs. Detailed explanations have been discussed in the above embodiments and thus are not repeated herein for the sake of brevity.

In some embodiments, as a high QP introduces more distortion which requires more refinement, a smaller maximum search round number can be set for low QP and a greater maximum search round number is set for high QP to keep the coding efficiency and reduce the complexity at the same time. Other methods for reducing complexity may also be used in low QP, as low QP case may not need too much refinement.

The search rounds may also be dependent on the sequence resolution. For example, for video sequences with large resolution, the maximum search round number or the neighboring positions to be searched in each round is set to a big value and for the video sequences with small resolution, the maximum search round number or the neighboring positions to be searched in each round is set to a small value.

In some embodiments, an inter-coded frame, like B frame and P frame, has one or more reference frames. The time distance between the current frame and reference frame impacts the accuracy of the inter prediction. Accordingly, in these embodiments, the parameter refinement process may depend on the temporal or the POC distance between the current frame and the reference frame. Detailed explanations have been discussed in the above embodiments and thus are not repeated herein for the sake of brevity.

In some embodiments, CPMV search can be performed. The refinement is not conducted directly on on-translation parameters, but on CPMVs. As the non-translation parameters are refined, each CPMV may have a different offset in the refinement that is different from base MV refinement in which all the CPMVs have the same offset in the refinement. If the three initial CPMVs are denoted as CPMV0, CPMV1 and CPMV2 and the three refined CPMVs are denoted as CPMV0′, CPMV1′ and CPMV2′, their relations can be expressed in the following equations:

$$\{ \begin{matrix}{CPMV}^{′} = CPMV 0 + M {V}_{offset 0} \\ CPMV {1}^{′} = CPMV 1 + M {V}_{offset 1} \\ CPMV {2}^{′} = CPMV 2 + M {V}_{offset 2}\end{matrix} \qquad ( 57 )$$

where MV_{offset0}, MV_{offset1} and MV_{offset2} are the three MV offsets searched in the TM refinement process for three CPMVs. For each search position, the sub-template MVs are derived according to the CPMVs corresponding to the search position, and the TM cost is calculated accordingly. The CPMVs producing the minimum TM cost is treated as the refined CPMVs output by the TM refinement process.

All the search methods and the complexity reduction methods used in non-translation parameter search can be used in the CPMV search.

In the exiting technology for affine motion compensation, the affine model is a linear model captured by two or three CPMVs. Normally top-left, top-right and left-bottom corners of the current coding block are used as the control point, and all the subblocks MV are derived from these three CPMVs according to the linear affine model which corresponds to a plane in three-dimension coordinate system. However, a coding block has four corners, of which the fourth corner is not used by the affine model. For example, for a 6-parameter affine model represented by the top-left, top-right and bottom-left CPMVs, as shown in FIG. 6, the bottom-right motion information is lost during the derivation of the subblock MVs, which leads to inaccuracy of the subblock MVs derived, especially for those subblocks near the bottom-right corner of the coding blocks. Moreover, although affine motion model can capture more complex motion than translation, such as rotation, zooming and shear mapping, non-linear motion still cannot be handled.

The present disclosure provides solutions to one or more of the above problems. In some embodiments, a bilinear model can be used. To solve the above-mentioned issue, it is proposed to extend affine model to bilinear model which is represented by the four CPMVs with a non-linear model, which can be expressed by the following equations:

$$\{ \begin{matrix}{mv}_{x} = a ( x - w ) + b ( y - h ) + e ( x - w ) ( y - h ) + m {v}_{0 x} \\ {mv}_{y} = c ( x - w ) + d ( y - h ) + f ( x - w ) ( y - h ) + m {v}_{0 y}\end{matrix} \qquad ( 58 )$$

where (mv₀ₓ, mv_{0y}) are the base MV of the bilinear model, parameters a, b, c, d, e and f are non-translation parameters of the bilinear model, of which a, b, c and d are linear parameters, and e and f are non-linear parameters defining the non-linear motion field of the bi-linear model. w and h are the width and height of the coding block. (mvₓ, mv_{y}) are the MV of the sample at coordinate (x, y). In the above equations, the MV of the top-left corner is set as the base MV, so the origin of the coordinate system is the top-left corner of the coding block. The bilinear model is a non-linear model, and when the origin of the coordinate system changes, the non-linear parameter e and f change accordingly.

Similar to the affine mode, the bilinear model can be represented by four CPMVs, which, for example, can be the top-left, top-right, bottom-left and bottom-right corner of the current coding block. For the four CPMVs being (mv₀ₓ, mv_{0y}), (mv₁ₓ, mv_{1y}), (mv₂ₓ, mv_{2y}), (mv₃ₓ, mv_{3y}), respectively, the non-translation parameters can be derived based on the following equations:

$$\{ \begin{matrix}a = \frac{{mv}_{1 x} - {mv}_{0 x}}{W} \\ b = \frac{{mv}_{2 x} - {mv}_{0 x}}{H} \\ c = \frac{m {v}_{1 y} - m {v}_{0 y}}{W} \\ d = \frac{m {v}_{2 y} - m {v}_{0 y}}{H} \\ e = \frac{( m {v}_{0 x} + m {v}_{3 x} - m {v}_{1 x} - m {v}_{2 x} )}{W \times H} \\ f = \frac{( m {v}_{0 y} + m {v}_{3 y} - m {v}_{1 y} - m {v}_{2 y} )}{W \times H}\end{matrix} \qquad ( 59 )$$

In some embodiments, a bilinear AMVP mode can be used. As the bilinear model is represented by four CPMVs, to support bilinear model in AMVP mode, four motion vector differences (MVDs) are signaled. First, a bilinear model flag is signaled to indicate whether the bilinear model is used. If the flag is on, then four MVDs are signaled. In another example, a model index can be signaled to indicate which one of 4-parameter affine mode, 6-parameter affine mode and 8-parameter bilinear mode is used. When the bilinear mode is used, four MVDs are signaled.

Before the signaling of the MVDs, the motion vector predictor (MVP) of four CPMVs are derived first. The MVPs of the first three CPMVs can be derived using the current methods. For the fourth CPMV, as it is at the bottom-right corner of the coding block, almost no spatial neighboring coding information can be used. Thus, the MVP of the bottom-right CPMV can be derived based on the temporal motion vector predictor (TMVP) which is from the motion information of the coding blocks in the reference pictures. In another example, the MVP of the bottom-right CPMV can be derived based on the MVPs of other three CPMVs. For the MVP of the top-left CPMV, top-right CPMV and bottom-left CPMV being (mvp₀ₓ, mvp_{0y}), (mvp₁ₓ, mvp_{1y}), (mvp₂ₓ, mvp_{2y}), the MVP of the bottom-right CPMV (mvp₃ₓ, mvp_{3y}) can be derived based on the following equations:

$$\{ \begin{matrix}{mvp}_{3 x} = m v {p}_{1 x} + m v {p}_{2 x} - m v {p}_{0 x} \\ {mvp}_{3 y} = m v {p}_{1 y} + m v {p}_{2 y} - m v {p}_{0 y}\end{matrix} \qquad ( 60 )$$

After the derivation of MVPs, the MVDs can be calculated as the difference between the MVP and MV determined by the motion estimation in encoder side for each control point. When signaling the MVDs, the MVDs can be predicted again and the residual of the MVDs are signaled. In some embodiments, the first, second, and third MVDs can be predicted and signaled according to the current method used in 6-parameter affine mode, and the MVD of the fourth CPMV can be predicted based on the first, second, and third MVDs. For example, for the decoded MVDs of the top-left CPMV, top-right CPMV and bottom-left CPMV being (mvd₀ₓ, mvd_{0y}), (mvd₁ₓ, mvd_{1y}), (mvd₂ₓ, mvd_{2y}), the predictor of the MVD of the bottom-right CPMV (mvdp₃ₓ, mvdp_{3y}) can be derived based on the following equations:

$$\{ \begin{matrix}{mvdp}_{3 x} = m v {d}_{1 x} + m v {d}_{2 x} - m v {d}_{0 x} \\ {mvdp}_{3 y} = m v {d}_{1 y} + m v {d}_{2 y} - m v {d}_{0 y}\end{matrix} \qquad ( 61 )$$

Then at the encoder side, the difference between the MVD of the bottom-right CPMV and the predictor of MVD of the bottom-right CPMV is signaled in the bitstream, denoted as (mvdd₃ₓ, mvdd_{3y}), where mvdd₃ₓ=mvd₃ₓ−mvdp₃ₓ and mvdd_{3y}=mvd_{3y}−mvdp_{3y}. At the decoded side, after decoding the difference between the MVD of the bottom-right CPMV and the predictor of MVD of the bottom-right CPMV, the MVD of the bottom-right CPMV can be derived based on the following equations:

$$\{ \begin{matrix}{mvd}_{3 x} = m v d {p}_{3 x} + m v d {d}_{3 x} \\ {mvd}_{3 y} = m v d {p}_{3 y} + m v d {d}_{3 y}\end{matrix} \qquad ( 62 )$$

In addition, the bottom-right CPMV can be derived based on the following equations:

$$\{ \begin{matrix}{mv}_{3 x} = m v {p}_{3 x} + m v {d}_{3 x} \\ {mv}_{3 y} = m v {p}_{3 y} + m v {d}_{3 y}\end{matrix} \qquad ( 63 )$$

where (mv₃ₓ, mv_{3y}) is the bottom-right CPMV and (mvp₃ₓ, mvp_{3y}) is the predictor of bottom-right CPMV.

In some embodiments, a bilinear merge mode can be used. For example, the bilinear mode can also be used in merge mode. When the bilinear mode is used in merge mode, the model information of the current coding block is inherited from the previously coded block and after decoding, the model information is stored and to be used by the other coding blocks in the future.

In some embodiments, a mode flag for bilinear mode is introduced. If the current block is coded by bilinear mode, the flag is set to true and stored in the memory. During the merge candidate derivation, the bilinear mode flag of the current merge candidate can also be inherited from the previously coded blocks.

In some other embodiments, there is no explicit flag for bilinear mode. In this case, the bilinear mode is treated as 8-parameter affine model which contains four CPMVs. Accordingly, if the current block is coded by bilinear mode, the four CPMVs are all stored and used for the future coding blocks. During the merge candidate derivation, if the previously coded block contains four CPMVs, the bilinear model information is extracted and inherited.

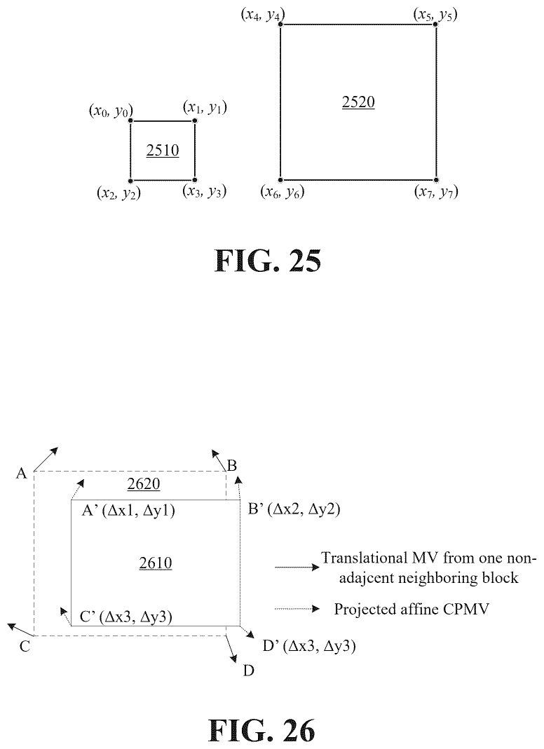

To support bilinear mode, the affine merge candidate construction is extended. For inherited candidates, the inherited bilinear candidates are derived from bilinear model of the adjacent or non-adjacent blocks. When an adjacent or non-adjacent bilinear coding block is identified, its control point motion vectors are used to derive the CPMVP candidate in the affine merge list of the current coding block. FIG. 25 is a schematic diagram illustrating control point motion vector inheritance, according to some embodiments of the present disclosure. As shown in FIG. 25, if the neighboring left bottom block 2510 is coded in bilinear mode, the motion vectors v₀, v₁, v₂ and v₃ of the top-left corner, above-right corner and left-bottom corner and right-bottom corner of the coding block which contains the block 2510 are attained. When block 2510 is coded with bilinear model, the four CPMVs of the current coding block 2520 with the corner positions (x₄, y₄), (x₅, y₅), (x₆,y₆) and (x₇, y₇) are calculated according to v₀, v₁, v₂ and v₃.

For inherited candidate from non-adjacent neighbors, the non-adjacent spatial neighbors are checked based on their distances to the current block, i.e., from near to far. At a specific distance, only the first available neighbor (being coded with the affine mode) from each side (e.g., the left and above) of the current block is included for inherited candidate derivation. As indicated by the dash arrows in FIG. 8A, the checking orders of the neighbors on the left and above sides are bottom-to-up and right-to-left, respectively. When checked coding block is coded with bilinear mode, the four CPMVs of the coding block are used to derive the four CPMVs of the current coding block based on the bilinear model equation.

Constructed bilinear candidates from adjacent neighbors are the candidates constructed by combining the neighbor translational motion information of each control point. The motion information for the control points is derived from the specified spatial neighbors and temporal neighbor shown in FIG. 9. CPMVₖ (k=1, 2, 3, 4) represents the k-th control point. For CPMV₁, the B2, B3, A2 blocks are checked in order and the MV of the first available block is used. For CPMV₂, the B1, B0 blocks are checked in order and for CPMV₃, the A1, A0 blocks are checked in order. TMVP is used as CPMV₄ if it's available. After MVs of four control points are attained, affine merge candidates and bilinear merge candidates are constructed based on those motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃} and {CPMV₁, CPMV₂, CPMV₃, CPMV₄}.

The combination of 4 CPMVs constructs a bilinear merge candidate. The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

For the first type of constructed candidates, as shown in the FIG. 8B, the positions of one left and above non-adjacent spatial neighbors are determined independently first. After that, the location of the top-left neighbor can be determined accordingly, which can enclose a rectangular virtual block together with the left and above non-adjacent neighbors.

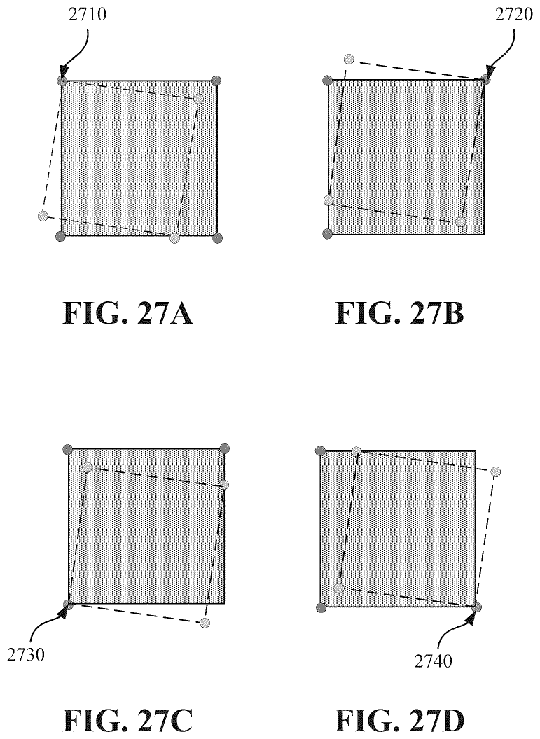

FIG. 26 is a schematic diagram illustrating the first type of constructed affine merge/AMVP candidates, according to some embodiments of the present disclosure. As shown in the FIG. 26, the motion information of the four non-adjacent neighbors is used to form the CPMVs at the top-left (A), top-right (B) bottom-left (C) and bottom-right (D) of the virtual block 2620, which is finally projected to the current coding block 2610 to generate the corresponding constructed candidates.

For the second type of constructed candidates, the non-translational parameters are inherited from the non-adjacent spatial neighbors. Specifically, the second type of bilinear constructed candidates are generated from the combination of (1) the base MV of adjacent neighboring 4×4 blocks, and (2) the non-translational parameters inherited from the non-adjacent spatial neighbors as defined in FIG. 8A. A first history-parameter table (HPT) is extended to store more parameters for bilinear model. An entry of the first HPT stores a set of non-translation parameters: a, b, c, d, e and f, and each of the parameter is represented by a 16-bit signed integer. Entries in HPT can be categorized by reference list and reference index. Five reference indices are supported for each reference list in HPT. In a formular way, the category of HPT (denoted as HPTCat) can be calculated based on the following equations:

$$HPTCat ( RefList , RefIdx ) = 5 \times RefList + min ( RefIdx , 4 ) \qquad ( 64 )$$

where RefList and RefIdx represent a reference picture list (0 or 1) and a reference index, respectively.

For each category, at most seven entries can be stored, resulting in total 70 entries in HPT. At the beginning of each CTU row, the number of entries for each category is initialized as zero. After decoding an affine-coded coding block or bilinear mode coded coding block with reference list RefListcur and RefIdxcur, the non-translation parameters are utilized to update entries in the category HPTCat(Ref_{Listeur}, RefIdx_{cur}) in a way similar to history-based motion vector predictor (HMVP) table updating. A history-non-translation-parameter-based candidate (HNTPC) is derived from one of the seven neighboring 4×4 blocks (denoted as A0, A1, A2, B0, B1, B2, B3 or T as in FIG. 9) and a set of non-translation parameters stored in a corresponding entry in the first HPT. The MV of a neighboring 4×4 block served as the base MV. In a formulating way, the MV of the current block at position (x, y) is calculated based on the following equations:

$$\{ \begin{matrix}\begin{matrix}m {v}^{h} ( x , y ) = a ( x - {x}_{b a s e} ) + b ( y - {y}_{b a s e} ) + \\ e ( x - {x}_{b a s e} ) ( y - {y}_{b a s e} ) + m {v}_{b a s e}^{h}\end{matrix} \\ \begin{matrix}m {v}^{v} ( x , y ) = c ( x - {x}_{b a s e} ) + d ( y - {y}_{b a s e} ) + \\ f ( x - {x}_{b a s e} ) ( y - {y}_{b a s e} ) + m {v}_{b a s e}^{v}\end{matrix}\end{matrix} \qquad ( 65 )$$

where (mv^{h}_{base}, mv^{v}_{base}) represents the MV of the neighboring 4×4 block, (xbase, ybase) represents the center position of the neighboring 4×4 block. (x, y) can be the top-left, top-right, bottom-left and bottom-right corner of the current block to obtain the corner-position MVs (CPMVs) for the current block, or can be the center of the current block to obtain a regular MV for the current block.

A second history-parameter table (HPT) with base MV information is also appended. There are nine entries in the second HPT, in which an entry includes a base MV, a reference index and at most six non-translation parameters for each reference list, and a base position. An additional merge HAPC can be generated from the second HPT with the base MV information the corresponding affine models or bilinear models stored in an entry. Moreover, pair-wised bilinear merge candidates can be generated by two bilinear merge candidates which are history-derived or not history-derived. A pair-wised bilinear merge candidate is generated by averaging the CPMVs of existing bilinear merge candidates in the list.

For the regression based bilinear merge candidates, the motion vectors and center positions from the neighboring subblocks of the current coding block, as illustrated in FIG. 12, are used as the input to the linear regression process to derive a set of model parameters. The subblock motion field from a previous coded affine coding block or bilinear mode coding block and the motion vectors from the adjacent subblocks of current coding block are used as the input for the regression process. The predicted CPMVs for current block are derived as output. The regression based bilinear merge candidates are derived and added to the affine merge list. The previously coded affine coding block or bilinear mode coding block can be identified from scanning through non-adjacent positions and the affine HMVP table. Adjacent subblock information of current coding block is fetched from 4×4 subblocks represented by the dotted area as depicted in FIG. 12. For each sub-block, given a reference list, the corresponding motion vector and center coordinate of the sub-block may be used. For each bilinear coding block, up to 2 bilinear candidates can be derived. One with adjacent subblock information and one without. All the linear-regression-generated candidates are pruned and collected into one candidate sub-group, TM cost-based ordering process may be applied. Afterwards, up to N linear-regression-generated candidates are added to the affine merge list.

In some embodiments, bilinear candidates derived from temporal collocated pictures are added to the affine merge candidate list. The same sampling pattern from the regular inter merge mode is reused to scan the predefined positions in the collocated pictures to derive the temporal bilinear candidates. If the scanned position belongs to a bilinear coded coding block, a new bilinear candidate is derived by scaling its CPMVs to the current coding block based on its position and block-size in the collocated picture and the derived new bilinear candidates are inserted into the existing affine merge list and reordered together with the other affine merge candidates or bilinear merge candidate by TM cost based reordering process.

After inserting all the above candidates into the candidate list, zero MVs can be inserted to the end of the list if the list is still not full.

In some embodiments, a DMVR for bilinear model can be used. The decoder motion vector refinement process may also be applied to a bilinear mode coded block. As the bilinear model contains base MV and non-translation parameters which are similar with affine model, the DMVR for bilinear mode coded blocks can also be divided into base MV refinement and non-translation parameter refinement.

In some embodiments, a base MV refinement can be used. In base MV refinement, the base MV (mv₀ₓ, mv_{0y}) is refined and the non-translation parameters, a, b, c, d, e, and f are fixed. In this stage, an optimal MV offset for base MV is searched by minimizing the BM cost (the SAD or SATD between L0 predictor and L1 predictor). After refinement, the optimal MV offset is added to the base MV and the subblock MVs are derived with the refined base MV based on the bilinear model equation. The search also obeys the following symmetrical rule:

$$\{ \begin{matrix}m {v}_{0 x} {\_l0}^{′} = {mv}_{0 x} \_l0 + m {v}_{offsetx} \\ m {v}_{0 x} {\_l1}^{′} = {mv}_{0 x} \_l1 - m {v}_{offsetx} \\ m {v}_{0 y} {\_l0}^{′} = {mv}_{0 y} \_l0 + m {v}_{offsety} \\ m {v}_{0 y} {\_l1}^{′} = {mv}_{0 y} \_l1 - m {v}_{offsety}\end{matrix} \qquad ( 66 )$$

where (mv₀ₓ_l0, mv_{0y}_l0) and (mv₀ₓ_l1, mv_{0y}_l1) are the initial base MV of the bilinear model for reference picture list 0 (RPL0) and reference picture list 1 (RPL1), respectively. (my₀ₓ_l0′, mv_{0y}_l0′) and (mv₀ₓ_l1′, mv_{0y}_l1′) are the refined base MV of the bilinear model for RPL0 and RPL1, respectively. (mv_{offsetx}, mv_{offsety}) are the base MV offset obtained in the search process.

Adding an MV offset to the base MV is equivalent to adding the same MV offset to all the CPMVs of the bilinear model. Thus, the base MV search process can also be implemented by CPMV searching process, which can be described based on the following equations:

$$\{ \begin{matrix}{CPMV0\_l0}^{′} = CPMV0\_l0 + M {V}_{offset} \\ {CPMV0\_l1}^{′} = CPMV0\_l1 - M {V}_{offset} \\ {CPMV1\_l0}^{′} = CPMV1\_l0 + M {V}_{offset} \\ {CPMV1\_l1}^{′} = CPMV1\_l1 - M {V}_{offset} \\ {CPMV2\_l0}^{′} = CPMV2\_l0 + M {V}_{offset} \\ {CPMV2\_l1}^{′} = CPMV2\_l1 - M {V}_{offset} \\ {CPMV3\_l0}^{′} = CPMV2\_l0 + M {V}_{offset} \\ {CPMV3\_l1}^{′} = CPMV2\_l1 - M {V}_{offset}\end{matrix} \qquad ( 67 )$$

where CPMV0_l0=(mv0_l0, mv_{y0}_l0), CPMV0_l1=(mv0_l1, mv_{y0}_l1) are RPL0 MV and RPL1 MV of the control point 0, CPMV1_l0=(mvₓ₁_l0, mv_{y1}_l0), CPMV1_l1=(mvₓ₁_l1, mv_{y1}_l1) are RPL0 MV and RPL1 MV of the control point 1, CPMV2_l0=(mvₓ₂_l0, mv_{y2}_l0), CPMV2_l1=(mvₓ₂_l1, mv_{y2}_l1) are RPL0 MV and RPL1 MV of the control point 2, CPMV3_l0=(mvₓ₃_l0, mv_{y3}_l0), CPMV3_l1=(mvₓ₃_l1, mv_{y3}_l1) are RPL0 MV and RPL1 MV of the control point 3, MV_{offset}=(mv_{offsetx}, mv_{offsety}) is the MV offset obtained in the search process.

For the calculation of the BM cost and the detailed search process, the base MV refinement method for affine model can also be used for the base MV refinement for bilinear model. The difference is that when refining the affine model, the MV offset is applied to the three CPMVs and when refining the bilinear model, the MV offset is applied to the four CPMVs. Similarly, the base MV refinement can also be applied to the subblock level, in which the subblock MVs are derived based on the bilinear model and added by a same MV offset in the search process.

To reduce the complexity, the base MV refinement can also be implemented at subblock level. And all the early termination method and other complexity reduction methods for base MV refinement of affine model can be used for the base MV refinement of bilinear model. These methods include but not limited to setting threshold for early termination, applying adaptively search process depending on video resolution, quantization parameter, etc.

In some embodiments, non-translation parameter MV refinement can be used. In addition to the base MV, the parameters of bilinear model can also be refined. Similar to the non-translation refinement of affine model, the refinement of non-translation parameter of bilinear can be described based on the following equations:

$$\{ \begin{matrix}{a\_l0}^{′} = a\_l0 - offset\_a \\ {a\_l1}^{′} = {a}_{l 1} ∓ offset\_a \\ {b\_l0}^{′} = b\_l0 + offset\_b \\ {b\_l1}^{′} = b\_l1 - offset\_b \\ {c\_l0}^{′} = c\_l0 + offset\_c \\ {c\_l1}^{′} = c\_l1 - offset\_c \\ {d\_l0}^{′} = d\_l0 + offset\_d \\ {d\_l1}^{′} = d\_l1 - offset\_d \\ {e\_l0}^{′} = e\_l0 + offset\_e \\ {e\_l1}^{′} = e\_l1 - offset\_e \\ {f\_l0}^{′} = f\_l0 + offset\_f \\ {f\_l1}^{′} = f\_l1 - offset\_f\end{matrix} \qquad ( 68 )$$

where a_l0, b_l0, c_l0, d_l0, e_l0 and f_l0 are the parameters of bilinear model for RPL0 and a_l1, b_l1, c_l1, d_l1 e_l1 and f_l1 are the parameters of bilinear model for RPL1. offset_a, offset_b, offset_c, offset_d, offset_d and offset_f are added to the parameters in a symmetrical manner to reduction the BM cost. a_l0′, b_l0′, c_l0′, d_l0′ e_l0′, f_l0′ and a_l1′, b_l1′, c_l1′, d_l1′, e_l1′, f_l1′ are the refined non-translation parameters for RPL0 and RPL1, respectively.

For each search point, subblock MVs are derived and motion compensation is performed on subblock level. The bilateral matching cost (SAD or SATD) can be calculated either at subblock level or coding block level. If the bilateral matching cost is calculated at the subblock level, after motion compensation of each subblock, the cost of that subblock is calculated and then after getting the costs of the subblocks, the coding block level cost is calculated by summing up all subblock costs. If the bilateral matching cost is calculated at the coding block level, the motion compensation of all the subblocks can be performed first to get the RPL0 and RPL1 predictor of the whole coding block, and then cost of the whole coding block is calculated. To reduce the calculation complexity, in some embodiments, only a part of subblocks or a part of samples of the coding block are considered in the bilateral matching cost calculation. That is, only the differences of a part of subblocks or a part of samples are calculated, so the motion compensation of the subblocks or the samples which are not considered in cost calculation can also be skipped.

For the search process, all the search method of non-translation parameter refinement of affine model can be used for the non-translation parameter refinement of bilinear model.

As there are 6 non-translation parameters to be refined. In some embodiments, the search is performed in six-dimension space. For example, the 3×3×3×3×3×3 square search or 3×3×3×3×3×3 cross search scheme may be applied to get the best parameter offset. For 3×3×3×3×3×3 square search scheme, for each central position, there are 728 neighboring positions to be searched and for 3×3×3×3×3×3 cross search, for each central position, there are 12 neighboring position to be searched which is much less than 3×3×3×3×3×3 square search. For the parameter offset of the current central position being (offset_a, offset_b, offset_c, offset_d, offset_e, offset_f), the neighboring positions to be searched in 3×3×3×3×3×3 cross search scheme is (offset_a+step_a, offset_b, offset_c, offset_d, offset_e, offset_f), (offset_a−step_a, offset_b, offset_c, offset_d, offset_e, offset_f), (offset_a, offset_b+step_b, offset_c, offset_d, offset_e, offset_f), (offset_a, offset_b−step_b, offset_c, offset_d, offset_e, offset_f), (offset_a, offset_b, offset_c+step_c, offset_d, offset_e, offset_f), (offset_a, offset_b, offset_c−step_c, offset_d, offset_e, offset_f), (offset_a, offset_b, offset_c, offset_d+step_d, offset_e, offset_f), (offset_a, offset_b, offset_c, offset_d−step_d, offset_e, offset_f), (offset_a, offset_b, offset_c, offset_d, offset_e+step_e, offset_f), (offset_a, offset_b, offset_c, offset_d, offset_e−step_e, offset_f), (offset_a, offset_b, offset_c, offset_d, offset_e, offset_f+step_f), (offset_a, offset_b, offset_c, offset_d, offset_e, offset−step_f), where step_a, step_b, step_c, step_d, step_e and step_f are search step for parameters a, b, c, d, e and f respectively. The search step can be dependent on the minimum subblock size, the largest coding block, and the MV precision. After getting the best parameter offset, error surface-based offsets estimation could also be applied to further refine the parameter with higher precision.

Similar to the non-translation parameter refinement of affine model, the iteration process can be applied. Since there are four CPMVs for bilinear model, the iteration process are shown in FIGS. 27A-27D. FIGS. 27A-27D are schematic diagrams illustrating example bilinear parameter refinements, according to some embodiments of the present disclosure. In the first step, the top-left CPMV 2710 is fixed as the base MV and the parameters are searched as shown in FIG. 27A. With the best parameters obtained, the top-right CPMV, bottom-left CPMV and bottom-right CPMV can be calculated. Then in the second step, as shown in FIG. 27B, the refined top-right CPMV 2720 is fixed and the parameters are refined again. With the best parameters obtained in the second step, the top-left CPMV, bottom-left CPMV and bottom-right CPMV can be calculated. And then in the third step, the refined bottom-left CPMV 2730 is fixed and the parameters are refined again as shown in FIG. 27C. With the best parameters obtained in the third step, the top-left CPMV, top-right CPMV, bottom-right CPMV can be calculated. In the fourth step, the bottom-right CPMV 2740 is fixed as the base MV and the parameters are searched as shown in FIG. 27D. With the best parameters obtained, the top-left CPMV, top-right CPMV, and bottom-left CPMV can be calculated. The above steps can be repeated multiple times. That is, the fourth step can be followed by the first step with new top-left CPMV 2710 fixed as base MV. And the process can be repeated until specific conditions are satisfied. For example, the conditions could be but not limited to: (1) a pre-set iteration number; (2) the SAD or SATD between RPL0 predictor and RPL1 predictor less than a threshold; (3) the current fixed CPMV is the same or similar as that in last iteration; or (4) the offset of the parameters in this round of search is less than a threshold.

In some embodiments, to reduce the complexity, the refinement of non-translation parameters a, b, c, d, e and f are in two steps. In the first step, parameters a, b, c and d are refined and in the second step, parameters e and f are refined. So, the first step of refinement can use the method of the non-translation parameter refinement for 6-parameter affine model. And in the second step, as only parameters e and f are to be refined. The search process is conducted in two-dimensional space. For example, the 3×3 square search or the 3×3 cross search as shown in FIG. 14 and FIG. 15 can be used. The iteration process as shown in FIGS. 27A-27D can also be applied. For the top-left CPMV, top-right CPMV, bottom-left CPMV and bottom-right CPMV for RPL0 denoted as (mv₀ₓ_l0, mv_{0y}_l0) (mv₁ₓ_l0, mv_{1y}_l0), (mv₂ₓ_l0, mv_{2y}_l0), and (mv₃ₓ_l0, mv_{3y}_l0), respectively, and the top-left CPMV, top-right CPMV, bottom-left CPMV and bottom-right CPMV for RPL1 denoted as (mv₀ₓ_l1, mv_{0y}_l1) (mv₁ₓ_l1, mv_{1y}_l1), (mv₂ₓ_l, mv_{2y}_l1) and (mv₃ₓ_l, mv_{3y}_l1), respectively, in the first iteration, the bottom-right CPMV is updated according to the new value of parameters e and f based on the following equations:

$$\{ \begin{matrix}m {v}_{3 x} {\_l0}^{′} = {mv}_{3 x} \_l0 + e \times w \times h \\ m {v}_{3 y} {\_l0}^{′} = {mv}_{3 y} \_l0 + e \times w \times h \\ m {v}_{3 x} {\_l1}^{′} = {mv}_{3 x} \_l1 - f \times w \times h \\ m {v}_{3 y} {\_l1}^{′} = {mv}_{3 y} \_l1 - f \times w \times h\end{matrix} \qquad ( 69 )$$

In the second iteration, the bottom-left CPMV is updated according to the new value of parameters e and f based on the following equations:

$$\{ \begin{matrix}{mv}_{2 x} {\_l0}^{′} = {mv}_{2 x} \_l0 + e \times w \times h \\ {mv}_{2 y} {\_l0}^{′} = {mv}_{2 y} \_l0 + e \times w \times h \\ {mv}_{2 x} {\_l1}^{′} = {mv}_{2 x} \_l1 - f \times w \times h \\ {mv}_{2 y} {\_l1}^{′} = {mv}_{2 y} \_l1 - f \times w \times h\end{matrix} \qquad ( 70 )$$

In the third iteration, the top-right CPMV is updated according to the new value of parameters e and f based on the following equations:

$$\{ \begin{matrix}{mv}_{1 x} {\_l0}^{′} = {mv}_{1 x} \_l0 + e \times w \times h \\ {mv}_{1 y} {\_l0}^{′} = {mv}_{1 y} \_l0 + e \times w \times h \\ {mv}_{1 x} {\_l1}^{′} = {mv}_{1 x} \_l1 - f \times w \times h \\ {mv}_{1 y} {\_l1}^{′} = {mv}_{1 y} \_l1 - f \times w \times h\end{matrix} \qquad ( 71 )$$

In the fourth iteration, the top-left CPMV is updated according to the new value of parameters e and f based on the following equations:

$$\{ \begin{matrix}{mv}_{0 x} \_l {0}^{′} = {mv}_{0 x} \_l0 + e \times w \times h \\ {mv}_{0 y} {\_l0}^{′} = {mv}_{0 y} \_l0 + e \times w \times h \\ {mv}_{0 x} {\_l1}^{′} = {mv}_{0 x} \_l1 - f \times w \times h \\ {mv}_{0 y} {\_l1}^{′} = {mv}_{0 y} \_l1 - f \times w \times h\end{matrix} \qquad ( 72 )$$

where (mv₀ₓ_l0′, mv_{0y}_l0′) (mv₁ₓ_l0′, mv_{1y}_l0′), (mv₂ₓ_l0′, mv_{2y}_l0′), and (mv₃ₓ_l0′, mv_{3y}_l0′) are the refined CPMVs of the top-left, top-right, bottom-left and bottom-right corner for RPL0. (mv₀ₓ_l1′, mv_{0y}_l1′) (mv₁ₓ_l1′, mv₁y_l1′), (mv₂ₓ_l1′, mv_{2y}_l1′), and (mv₃ₓ_l1′, mv_{3y}_l1′) are the refined CPMVs of the top-left, top-right, bottom-left and bottom-right corner for RPL1.

In some embodiments, non-translation parameter MV refinement can be used. For the cost of each search point, the difference of the parameter offsets could also be considered. That is, the cost could be a weighted sum as the following equation:

$$BMCost = w \times ParameterOffsetCost + sadCost \qquad ( 73 )$$

where w is a weight, sadCost is the SAD/SATD or mean removed SAD/SATD between RPL0 predictor and RPL1 predictor and ParameterOffsetCost is a cost dependent on the parameter offset of the refined parameters. When the weight w is equal to 0, only sadCost is considered.

In some embodiments, affine model to bilinear model can be extended. The refinement of bilinear model may also be applied on the affine coded blocks. When it is applied on the affine coded blocks. The refinement of affine model, including base MV refinement and non-translation refinement may be applied first. After that, the non-translation parameters e and f are refined. As in affine model, parameters e and f are both equal to 0. Thus, the initial value of parameters e and f are set to 0. after refinement, the parameters e and f may have non-zero values. In case that one of parameters e and f are not equal to 0, the affine model is extended to the bilinear model. The coding block is a bilinear mode coded block.

In some embodiments, when applying bilinear model refinement on affine coded block, the bottom-right CPMV can be initialized based on the following equations:

$$\{ \begin{matrix}{mv}_{3 x} = m {v}_{1 x} + m {v}_{2 x} - m {v}_{0 x} \\ {mv}_{3 y} = m {v}_{1 y} + m {v}_{2 y} - m {v}_{0 y}\end{matrix} \qquad ( 74 )$$

where (mv₀ₓ, mv₀ₓ) is the top-left CPMV, (mv₁ₓ, mv₁ₓ) is the top-right CPMV, (mv₂ₓ, mv₂ₓ) is the bottom-left CPMV and (mv₃ₓ, mv₃ₓ) is the bottom-right CPMV derived.

After derivation the initial value of the bottom-right CPMV, all the bilinear model refinement methods can be applied. After the refinement, the affine model is extended to a bilinear model. Thus, the current block is extended to a bilinear mode coded block.

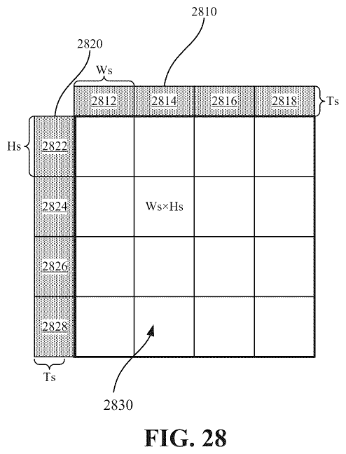

In some embodiments, a template matching (TM) based refinement for bilinear model can be used. For example, TM based refinement may also be applied on the bilinear model coded blocks. FIG. 28 illustrates an above template and a left template for a current bilinear mode coded block, according to some embodiments of the present disclosure. As bilinear motion compensation is performed at the subblock level, template of bilinear merge candidate also includes several sub-templates, which is the same as that of affine merge candidate shown in FIG. 20. If the template size used in TM is equal to Ts and the bilinear merge candidates with subblock size equal to Ws×Hs, the above template 2810 includes several sub-templates 2812, 2814, 2816, and 2818 with the size of Ws×Ts, and the left template 2820 includes several sub-templates 2822, 2824, 2826, and 2828 with the size of Ts×Hs as shown in FIG. 28, in which the white region is a current bilinear mode coded coding block including 16 subblocks 2830 and the dotted area is a template including 4 above sub-templates 2812, 2814, 2816, and 2818 with size of Ws×Ts and 4 left sub-templates 2822, 2824, 2826, and 2828 with size of Ts×Hs. Ts is the size of the template. For example, Ts could be 1, 2, 3 or 4.

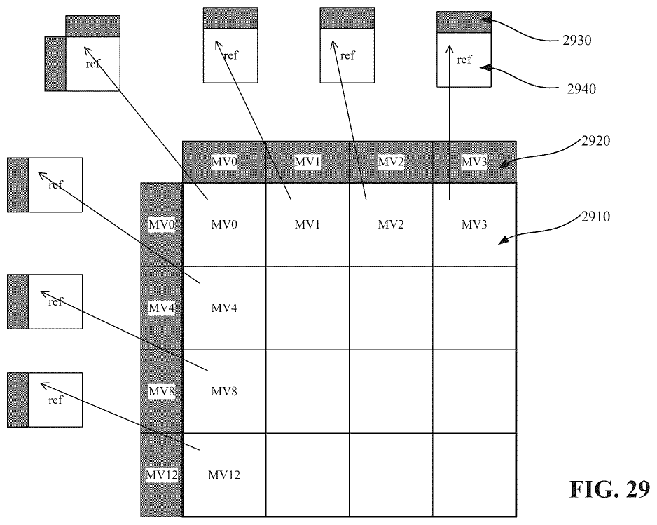

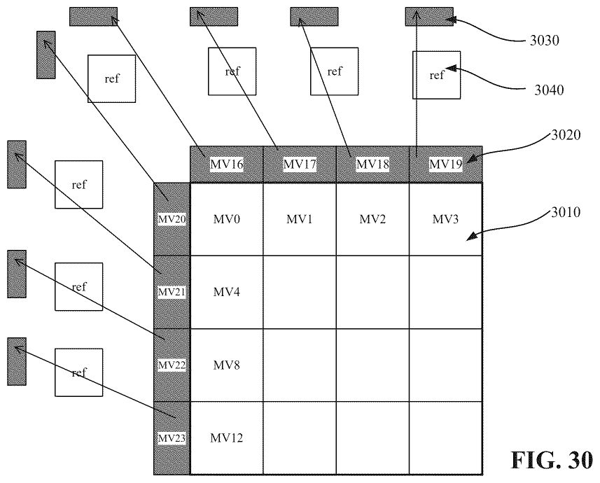

Similar to the MVs of sub-templates of an affine motion coded block, to get the template of the reference block, the MV of each subblock template needs to be derived. In some embodiments, the MV of each sub-template can be borrowed from the boundary subblock. That is, the MV of a sub-template is the same as the MV of the adjacent subblock within the current coding block. FIG. 29 illustrates MVs of sub-templates of a bilinear mode coded block, according to some embodiments of the present disclosure. As shown in FIG. 29, the white subblocks are the subblocks 2910 of the current coding block and the dotted subblocks are the sub-templates 2920. The MV value (e.g., MV0, MV1, MV2, MV3, MV4, MV8 and MV12) of the boundary subblock 2910 is the same as MV of the corresponding sub-template 2920. Thus, the sub-templates 2930 of reference block are adjacent to the reference subblocks 2940 which are marked as “ref.” In some other embodiments, the MV of sub-template can be derived based on the bilinear model based on the coordinate of each sub-template. Thus, each sub-template has its own MV which may be different from that of boundary subblock. FIG. 30 illustrates MVs of sub-templates of a bilinear mode coded block, according to some embodiments of the present disclosure. As shown in FIG. 30, the boundary subblocks 3010 have MV values marked as MV0, MV1, MV2, MV3, MV4, MV8 and MV12, and the sub-templates 3020 have MV values marked as MV16 to MV23. As the sub-template MVs may be different from the boundary subblock MVs, the sub-templates 3030 of the reference block may be separated from the reference blocks 3040.

In some embodiments, a base MV refinement can be used. Same as TM based refinement for affine coded blocks, the TM refinement for bilinear mode coded block can also be divided into base MV refinement and non-translation parameter refinement. In base MV refinement, the base MV (mv₀ₓ, mv_{0y}) is refined and the non-translation parameters, a, b, c, d, e, and f are fixed. In this stage, an optimal MV offset for base MV is searched by minimizing the TM cost (the difference between the template of current coding block and the template of the reference block). After refinement, the optimal MV offset is added to the base MV and the subblock MVs are derived with the refined base MV based on the bilinear model equation. The base MV refinement can be described as the following equations:

$$\{ \begin{matrix}{mv}_{0 x}^{′} = {mv}_{0 x} + m {v}_{offsetx} \\ {mv}_{0 y}^{′} = {mv}_{0 y} + m {v}_{offsety}\end{matrix} \qquad ( 75 )$$

where (mv₀ₓ, mv_{0y}) is the initial base MV of the bilinear model and (mv₀ₓ′, mv_{0y}′) is the refined base MV of the bilinear model. (mv_{offsetx}, mv_{offsety}) are the base MV offset obtained in the search process.

Adding an MV offset to the base MV is equivalent to adding the same MV offset to all the CPMVs of the bilinear model. Thus, the base MV search process can also be implemented by CPMV searching process, which can be described based on the following equations:

$$\{ \begin{matrix}{CPMV}^{′} = CPMV 0 + {MV}_{offset} \\ CPMV {1}^{′} = CPMV 1 + {MV}_{offset} \\ CPMV {2}^{′} = CPMV 2 + {MV}_{offset} \\ CPMV {3}^{′} = CPMV 3 + {MV}_{offset}\end{matrix} \qquad ( 76 )$$

where CPMV0=(mvₓ₀, mv_{y0}) is MV of the control point 0, CPMV1=(mvₓ₁, mv_{y1}), is MV of the first control point, CPMV2=(mvₓ₂, mv_{y2}), is MV of the second control point, CPMV3=(mvₓ₃, mv_{y3}), is MV of the third control point, MV_{offset}=(mv_{offsetx}, mv_{offsety}) is the MV offset obtained in the search process.

The base MV refinement is also equivalent to add the same MV offset to all the subblock MVs, which can be described based on the following equations:

$${subMV}^{′} = subMV + M {V}_{offset} \qquad ( 77 )$$

where subMV is the initial MV of a subblock within the coding block, subMV′ is the refined MV of the subblock, and MV_{offset} is the MV offset obtained in the search process.

All the search patterns and search methods used in the TM refinement and DMVR can be used for base MV refinement of bilinear model base MV refinement. All the early termination methods and fast algorithm used in TM refinement and DMVR can be used here to reduce complexity. For other detailed design, the current TM used for affine coded block or translation motion coded block can also be used.

In some embodiments, non-translation parameter refinement can be used. Similar with non-translation refinement of DMVR for bilinear model, in TM based refinement, the non-translation can also be refined based on the following equations:

$$\{ \begin{matrix}{a}^{′} = a + offset\_a \\ {b}^{′} = b + offset\_b \\ {c}^{′} = c + offset\_c \\ {d}^{′} = d + ffset\_d \\ {e}^{′} = d + ffset\_e \\ {f}^{′} = d + ffset\_f\end{matrix} \qquad ( 78 )$$

where a, b, c, d, e and f are initial non-translation parameters of bilinear model, a′, b′, c′, d′, e′ and f′ are the refined non-translation parameters of bilinear model, offset_a, offset_b, offset_c, offset_d, offset_e and offset_f are the parameter offsets searched in the TM refinement process.

After getting values of a′, b′, c′, e′, f′, the subblock MVs and sub-template MVs can be derived based on the bilinear model with a′, b′, c′, d′, e′, f′. The TM cost can be calculated as the difference between the template of reference block and the template of the current block. By comparing the TM costs corresponding to different values of offset_a, offset_b, offset_c, offset_d, offset_e and offset_f, the best non-translation parameter a′, b′, c′, d′, e′, f′ can be obtained as the refined non-translation parameters and the corresponding CPMVs can be calculated as the refined CPMVs.

For the search process, all the search method of non-translation parameter refinement of affine model can be used for the non-translation parameter refinement of bilinear model. As there are 6 non-translation parameters in the bilinear model to be refined. In some embodiments, the search is performed in six-dimension space. For example, the 3×3×3×3×3×3 square search or 3×3×3×3×3×3 cross search scheme may be applied to get the best parameter offset. For 3×3×3×3×3×3 square search scheme, for each central position, there are 728 neighboring positions to be searched and for 3×3×3×3×3×3 cross search, for each central position, there are 12 neighboring position to be searched which is much less than 3×3×3×3×3×3 square search. For the parameter offset of the current central position being (offset_a, offset_b, offset_c, offset_d, offset_e, offset_f), the neighboring positions to be searched in 3×3×3×3×3×3 cross search scheme is (offset_a+step_a, offset_b, offset_c, offset_d, offset_e, offset_f), (offset_a−step_a, offset_b, offset_c, offset_d, offset_e, offset_f), (offset_a, offset_b+step_b, offset_c, offset_d, offset_e, offset_f), (offset_a, offset_b−step_b, offset_c, offset_d, offset_e, offset_f), (offset_a, offset_b, offset_c+step_c, offset_d, offset_e, offset_f), (offset_a, offset_b, offset_c −step_c, offset_d, offset_e, offset_f), (offset_a, offset_b, offset_c, offset_d+step_d, offset_e, offset_f), (offset_a, offset_b, offset_c, offset_d −step_d, offset_e, offset_f), (offset_a, offset_b, offset_c, offset_d, offset_e+step_e, offset_f), (offset_a, offset_b, offset_c, offset_d, offset_e−step_e, offset_f), (offset_a, offset_b, offset_c, offset_d, offset_e, offset_f+step_f), (offset_a, offset_b, offset_c, offset_d, offset_e, offset−step_f), where step_a, step_b, step_c, step_d, step_e and step_f are search step for parameter a, b, c, d, e and f respectively. The search step can be dependent on the minimum subblock size, the largest coding block, and the MV precision. After getting the best parameter offset, error surface-based offsets estimation could also be applied to further refine the parameter with higher precision.

Similar to the non-translation parameter refinement of affine model, the iteration process can be applied. Since there are four CPMVs for bilinear model, the iteration processes are shown in FIGS. 27A-27D, which have been discussed above and thus are not repeated herein for the sake of brevity.

In some embodiments, to reduce the complexity, the refinement of non-translation parameters a, b, c, d, e and f are in two steps. In the first step, parameters a, b, c and d are refined and in the second step, parameters e and f are refined. So, the first step of refinement can use the method of the non-translation parameter refinement for 6-parameter affine model. And in the second step, as only parameters e and f are to be refined. Detailed operations have been discussed in the above embodiments and thus are not repeated herein for the sake of brevity. For the top-left CPMV, top-right CPMV, bottom-left CPMV and bottom-right CPMV denoted as (mv₀ₓ, mv₀ₓ) (mv₁ₓ, mv₁ₓ), (mv₂ₓ, mv₂ₓ), and (mv₃ₓ, mv₃ₓ), respectively, in the first iteration, the bottom-right CPMV is updated according to the new value of parameters e and f based on the following equations:

$$\{ \begin{matrix}m {v}_{3 x}^{′} = m {v}_{3 x} + e \times w \times h \\ {mv}_{3 y}^{′} = {mv}_{3 y} + f \times w \times h\end{matrix} \qquad ( 79 )$$

In the second iteration, the bottom-left CPMV is updated according to the new value of parameters e and f based on the following equations:

$$\{ \begin{matrix}{mv}_{2 x}^{′} = m {v}_{2 x} - e \times w \times h \\ {mv}_{2 y}^{′} = m {v}_{2 y} - f \times w \times h\end{matrix} \qquad ( 80 )$$

In the third iteration, the top-right CPMV is updated according to the new value of parameters e and f based on the following equations:

$$\{ \begin{matrix}{mv}_{1 x}^{′} = m {v}_{1 x} - e \times w \times h \\ {mv}_{1 y}^{′} = m {v}_{1 y} - f \times w \times h\end{matrix} \qquad ( 81 )$$

In the fourth iteration, the top-left CPMV is updated according to the new value of parameters e and f based on the following equations:

$$\{ \begin{matrix}{mv}_{0 x}^{′} = m {v}_{0 x} + e \times w \times h \\ {mv}_{0 y}^{′} = {mv}_{0 y} + f \times w \times h\end{matrix} \qquad ( 82 )$$

where (mv₀ₓ′, mv_{0y}′) (mv₁ₓ′, mv_{1y}′), (mv₂ₓ′, mv_{2y}′), and (mv₃ₓ′,mv_{3y}′) are the refined CPMVs of the top-left, top-right, bottom-left and bottom-right corner.

For the cost of each search point, the difference of the parameter offsets could also be considered. That is, the cost could be a weighted sum of parameter offset and the SAD or SATD between the template of the reference block and the template of the current block as the following equation:

$$TMCost = w \times ParameterOffsetCost + sadCost \qquad ( 83 )$$

where w is a weight, sadCost is the SAD/SATD or mean removed SAD/SATD cost of the templates and ParameterOffsetCost is a cost dependent on the parameter offset of the refined parameters. When the weight w is equal to 0, only sadCost is considered.

To reduce the search complexity, the early termination method or other adaptive search method used in affine TM refinement can also be used for bilinear TM refinement.

The refinement of bilinear model may also be applied on the affine coded blocks. When it is applied on the affine coded blocks. The refinement of affine model, including base MV refinement and non-translation parameters refinement may be applied first. After that, the non-translation parameters e and f are refined. As in affine model, parameters e and f are both equal to 0. Thus, the initial value of parameters e and f are set to 0. after refinement, the parameters e and f may have non-zero values. In case that one of parameters e and f are not equal to 0, the affine model can be extended to the bilinear model. The coding block is a bilinear mode coded block.

In some embodiments, when applying bilinear model refinement on affine coded block, the bottom-right CPMV is initialized based on the following equations:

$$\{ \begin{matrix}{mv}_{3 x} = m {v}_{1 x} + m {v}_{2 x} - m {v}_{0 x} \\ {mv}_{3 y} = m {v}_{1 y} + m {v}_{2 y} - m {v}_{0 y}\end{matrix} \qquad ( 84 )$$

where (mv₀ₓ, mv_{0y}) is the top-left CPMV, (mv₁ₓ, mv_{1y}) is the top-right CPMV, (mv₂ₓ, mv_{2y}) is the bottom-left CPMV and (mv₃ₓ, mv_{3y}) is the bottom-right CPMV derived.

After the derivation of the initial value of the bottom-right CPMV, all the bilinear model refinement methods can be applied. After the refinement, the affine model is extended to a bilinear model. Thus, the current block can be extended to a bilinear mode coded block.

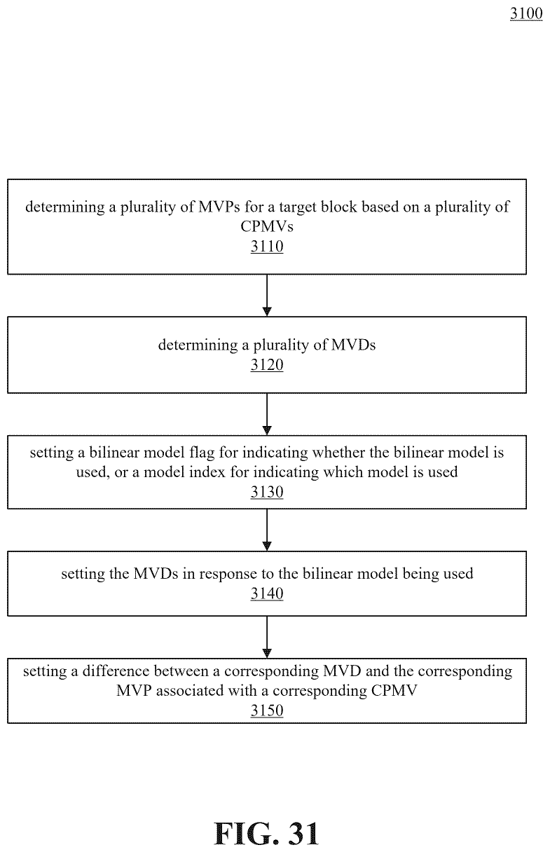

FIG. 31 is a flowchart for an example method 3100 for encoding a video bitstream, according to some embodiments of the present disclosure. The method 3100 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the method 3100. As shown in FIG. 31, the method 3100 includes the following steps 3110-3150.

At step 3110, the encoder determines a plurality of motion vector predictors (MVP) for a target block based on a plurality of control point motion vectors (CPMV). A bilinear model is represented by the plurality of CPMVs. The bilinear model includes a plurality of linear parameters and a plurality of non-linear parameters, and a base motion vector (MV).

At step 3120, the encoder determines a plurality of motion vector differences (MVD). Each motion vector difference is based on a difference between the corresponding MVP and the CPMV for each control point. For example, four motion vector differences (MVDs) may be respectively associated with the top-left CPMV, top-right CPMV, bottom-left CPMV and bottom-right CPMV.

At step 3130, the encoder sets, in the bitstream, a bilinear model flag for indicating whether the bilinear model is used, or a model index for indicating which model is used. For example, if the bilinear model flag is on, then four MVDs are set and signaled. In another example, the model index can be set and signaled to indicate which one of 4-parameter affine mode, 6-parameter affine mode and 8-parameter bilinear mode is used.

At step 3140, the encoder sets the plurality of MVDs in the bitstream, in response to the bilinear model being used. For example, as the bilinear model is represented by four CPMVs, to support bilinear model in AMVP mode, four motion vector differences (MVDs) associated with the top-left CPMV, top-right CPMV, bottom-left CPMV and bottom-right CPMV can be set.

At step 3150, the encoder sets, in the bitstream, a difference between a corresponding MVD and the corresponding MVP associated with a corresponding CPMV. In some embodiments, the encoder may determine the corresponding MVP based on a first MVD, a second MVD, and a third MVD of the plurality of MVDs. For example, the difference between the MVD of the bottom-right CPMV and the predictor of MVD of the bottom-right CPMV can be set and signaled in the bitstream. For example, the predictor of the MVD of the bottom-right CPMV (mvdp₃ₓ, mvdp_{3y}) can be derived based on the decoded MVDs of the top-left CPMV, top-right CPMV and bottom-left CPMV, i.e., (mvd₀ₓ, mvd_{0y}), (mvd₁ₓ, mvd_{1y}), (mvd₂ₓ, mvd_{2y}). In some embodiments, the encoder transmits the bitstream through a public network or a private network.

In some embodiments, in the method 3100, the encoder may further use the bilinear model in a merge mode by constructing a bilinear merge candidate using a combination of the plurality of CPMVs. The operations of the bilinear merge mode are discussed above in detail in the embodiments of the present disclosure, and thus are not repeated herein for the sake of brevity.

In some embodiments, in the method 3100, the encoder may further perform a base MV refinement for the bilinear model to refine the base motion vector of the bilinear model and keep the plurality of linear parameters and the plurality of non-linear parameters fixed, or perform a parameter refinement for the bilinear model to refine the plurality of linear parameters and the plurality of non-linear parameters. The operations of the base MV refinement and the parameter refinement for the bilinear model are discussed above in detail in the embodiments of the present disclosure, and thus are not repeated herein for the sake of brevity.

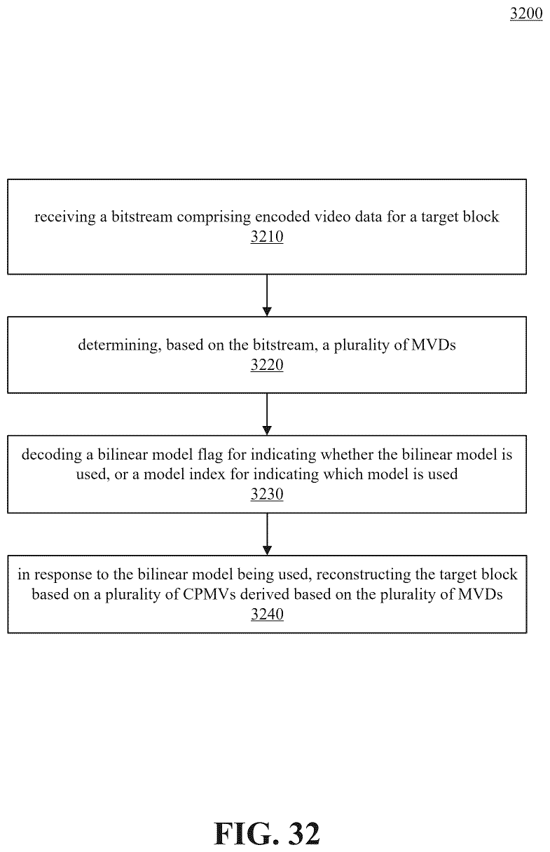

FIG. 32 is a flowchart for an example method 3200 for decoding a video bitstream, according to some embodiments of the present disclosure. In some embodiments, the method 3200 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 3200. As shown in FIG. 32, the method 3200 may include steps 3610-3640.

At step 3210, the decoder receives a bitstream including encoded video data for a target block. At step 3220, the decoder determines, based on the bitstream, a plurality of motion vector differences (MVD). Each MVD is based on a difference between a corresponding motion vector predictor (MVP) and a control point motion vector (CPMV) for each control point of the target block.

At step 3230, the decoder decodes, from the bitstream, a bilinear model flag for indicating whether a bilinear model is used, or a model index for indicating which model is used. The bilinear model includes a plurality of linear parameters and a plurality of non-linear parameters, and a base motion vector (MV). Details of the bilinear model flag or the model index are the same or similar to those of steps 3130 in FIG. 31 discussed above, and thus are not repeated herein for the sake of brevity.

At step 3240, the decoder, in response to the bilinear model being used, reconstructs the target block based on a plurality of CPMVs derived based on the plurality of MVDs. The bilinear model is represented by the plurality of CPMVs. In some embodiments, the decoder may decode, from the bitstream, a difference between a corresponding MVD and a corresponding MVP associated with a corresponding CPMV. Then, the decoder may derive the corresponding MVD based on the decoded difference and the corresponding MVP, and derive the corresponding CPMV based on the corresponding MVD and the corresponding MVP. For example, after decoding the difference between the MVD of the bottom-right CPMV and the predictor of MVD of the bottom-right CPMV, the MVD of the bottom-right CPMV can be derived. Then, the bottom-right CPMV can be derived accordingly.

In some embodiments, in the method 3200, the decoder may further use the bilinear model in a merge mode by constructing a bilinear merge candidate using a combination of the plurality of CPMVs. The operations of the bilinear merge mode are discussed above in detail in the embodiments of the present disclosure, and thus are not repeated herein for the sake of brevity.

In some embodiments, in the method 3200, the decoder may further perform a base MV refinement for the bilinear model to refine the base motion vector of the bilinear model and keep the plurality of linear parameters and the plurality of non-linear parameters fixed, or perform a parameter refinement for the bilinear model to refine the plurality of linear parameters and the plurality of non-linear parameters. The operations of the base MV refinement and the parameter refinement for the bilinear model are discussed above in detail in the embodiments of the present disclosure, and thus are not repeated herein for the sake of brevity.

The embodiments described in the present disclosure can be freely combined.

In some embodiments, a non-transitory computer-readable storage medium storing a bitstream is also provided. The bitstream can be encoded and decoded based on the disclosed bilinear model for video coding.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

In some embodiments, a method for storing a bitstream is also provided. The method includes receiving a video sequence including one or more pictures, generating a bitstream including coded information associated with the video sequence, and storing the bitstream in a non-transitory computer-readable medium. The operations of generating the bitstream include steps that are the same or similar to those of method 3100 in FIG. 31 discussed above, and thus are not repeated herein for the sake of brevity.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method for encoding video data, comprising:
determining a plurality of motion vector predictors (MVP) for a target block based on a plurality of control point motion vectors (CPMV), wherein a bilinear model is represented by the plurality of CPMVs;
determining a plurality of motion vector differences (MVD), wherein each motion vector difference is based on a difference between the corresponding MVP and the CPMV for each control point; and
setting the plurality of MVDs in a bitstream, in response to the bilinear model being used.

2. The method of clause 1, further comprising:
setting, in the bitstream, a bilinear model flag for indicating whether the bilinear model is used, or a model index for indicating which model is used.

3. The method of clause 1 or 2, further comprising:
determining a corresponding MVP based on a first MVD, a second MVD, and a third MVD of the plurality of MVDs; and
setting, in the bitstream, a difference between a corresponding MVD and the corresponding MVP associated with a corresponding CPMV.

4. The method of any of clauses 1-3, further comprising:
using the bilinear model in a merge mode by constructing a bilinear merge candidate using a combination of the plurality of CPMVs.

5. The method of any of clauses 1-4, wherein the bilinear model comprises a plurality of linear parameters and a plurality of non-linear parameters, and a base motion vector (MV).

6. The method of clause 5, further comprising:
performing a base MV refinement for the bilinear model to refine the base motion vector of the bilinear model and keep the plurality of linear parameters and the plurality of non-linear parameters fixed.

7. The method of clause 5 or 6, further comprising:
performing a parameter refinement for the bilinear model to refine the plurality of linear parameters and the plurality of non-linear parameters.

8. The method of any of clauses 1-7, further comprising:
transmitting the bitstream through a public network or a private network.

9. A method for decoding a video bitstream, comprising:
receiving a bitstream comprising encoded video data for a target block;
determining, based on the bitstream, a plurality of motion vector differences (MVD), wherein each motion vector difference is based on a difference between a corresponding motion vector predictor (MVP) and a control point motion vector (CPMV) for each control point of the target block; and
in response to a bilinear model being used, reconstructing the target block based on a plurality of CPMVs derived based on the plurality of MVDs, wherein the bilinear model is represented by the plurality of CPMVs.

10. The method of clause 9, further comprising:
decoding, from the bitstream, a bilinear model flag for indicating whether the bilinear model is used, or a model index for indicating which model is used.

11. The method of clause 9 or 10, further comprising:
decoding, from the bitstream, a difference between a corresponding MVD and a corresponding MVP associated with a corresponding CPMV; and
deriving the corresponding MVD based on the decoded difference and the corresponding MVP; and
deriving the corresponding CPMV based on the corresponding MVD and the corresponding MVP.

12. The method of any of clauses 9-11, further comprising:
using the bilinear model in a merge mode by constructing a bilinear merge candidate using a combination of the plurality of CPMVs.

13. The method of any of clauses 9-12, wherein the bilinear model comprises a plurality of linear parameters and a plurality of non-linear parameters, and a base motion vector (MV).

14. The method of clause 13, further comprising:
performing a base MV refinement for the bilinear model to refine the base motion vector of the bilinear model and keep the plurality of linear parameters and the plurality of non-linear parameters fixed.

15. The method of clause 13 or 14, further comprising:
performing a parameter refinement for the bilinear model to refine the plurality of linear parameters and the plurality of non-linear parameters.

16. A method for storing a bitstream, comprising:
receiving a video sequence including one or more pictures;
generating a bitstream comprising coded information associated with the video sequence, by:
   determining a plurality of motion vector predictors (MVP) for a target block of the one or more pictures based on a plurality of control point motion vectors (CPMV), wherein a bilinear model is represented by the plurality of CPMVs;
   determining a plurality of motion vector differences (MVD), wherein each motion vector difference is based on a difference between the corresponding MVP and the CPMV for each control point; and
   coding the plurality of MVDs in the bitstream, in response to the bilinear model being used; and
storing the bitstream in a non-transitory computer-readable medium.

17. The method of clause 16, wherein the coded information comprises:
a bilinear model flag for indicating whether the bilinear model is used, or a model index for indicating which model is used.

18. The method of clause 16 or 17, wherein the coded information comprises:
a difference between a corresponding MVD and a corresponding MVP associated with a corresponding CPMV.

19. The method of any of clauses 16-18, the generating of the bitstream further comprising:
using the bilinear model in a merge mode by constructing a bilinear merge candidate using a combination of the plurality of CPMVs.

20. The method of clauses 16-19, wherein the bilinear model comprises a plurality of linear parameters and a plurality of non-linear parameters, and a base motion vector (MV).

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for encoding video data, comprising:
determining a plurality of motion vector predictors (MVP) for a target block based on a plurality of control point motion vectors (CPMV), wherein a bilinear model is represented by the plurality of CPMVs;
determining a plurality of motion vector differences (MVD), wherein each motion vector difference is based on a difference between the corresponding MVP and the CPMV for each control point; and
setting the plurality of MVDs in a bitstream, in response to the bilinear model being used.

2. The method of claim 1, further comprising:
setting, in the bitstream, a bilinear model flag for indicating whether the bilinear model is used, or a model index for indicating which model is used.

3. The method of claim 1, further comprising:
determining a corresponding MVP based on a first MVD, a second MVD, and a third MVD of the plurality of MVDs; and
setting, in the bitstream, a difference between a corresponding MVD and the corresponding MVP associated with a corresponding CPMV.

4. The method of claim 1, further comprising:
using the bilinear model in a merge mode by constructing a bilinear merge candidate using a combination of the plurality of CPMVs.

5. The method of claim 1, wherein the bilinear model comprises a plurality of linear parameters and a plurality of non-linear parameters, and a base motion vector (MV).

6. The method of claim 5, further comprising:
performing a base MV refinement for the bilinear model to refine the base motion vector of the bilinear model and keep the plurality of linear parameters and the plurality of non-linear parameters fixed.

7. The method of claim 5, further comprising:
performing a parameter refinement for the bilinear model to refine the plurality of linear parameters and the plurality of non-linear parameters.

8. The method of claim 1, further comprising:
transmitting the bitstream through a public network or a private network.

9. A method for decoding a video bitstream, comprising:
receiving a bitstream comprising encoded video data for a target block;
determining, based on the bitstream, a plurality of motion vector differences (MVD), wherein each motion vector difference is based on a difference between a corresponding motion vector predictor (MVP) and a control point motion vector (CPMV) for each control point of the target block; and
in response to a bilinear model being used, reconstructing the target block based on a plurality of CPMVs derived based on the plurality of MVDs, wherein the bilinear model is represented by the plurality of CPMVs.

10. The method of claim 9, further comprising:
decoding, from the bitstream, a bilinear model flag for indicating whether the bilinear model is used, or a model index for indicating which model is used.

11. The method of claim 9, further comprising:
decoding, from the bitstream, a difference between a corresponding MVD and a corresponding MVP associated with a corresponding CPMV; and
deriving the corresponding MVD based on the decoded difference and the corresponding MVP; and
deriving the corresponding CPMV based on the corresponding MVD and the corresponding MVP.

12. The method of claim 9, further comprising:
using the bilinear model in a merge mode by constructing a bilinear merge candidate using a combination of the plurality of CPMVs.

13. The method of claim 9, wherein the bilinear model comprises a plurality of linear parameters and a plurality of non-linear parameters, and a base motion vector (MV).

14. The method of claim 13, further comprising:
performing a base MV refinement for the bilinear model to refine the base motion vector of the bilinear model and keep the plurality of linear parameters and the plurality of non-linear parameters fixed.

15. The method of claim 13, further comprising:
performing a parameter refinement for the bilinear model to refine the plurality of linear parameters and the plurality of non-linear parameters.

16. A method for storing a bitstream, comprising:
receiving a video sequence including one or more pictures;
generating a bitstream comprising coded information associated with the video sequence, by:
determining a plurality of motion vector predictors (MVP) for a target block of the one or more pictures based on a plurality of control point motion vectors (CPMV), wherein a bilinear model is represented by the plurality of CPMVs;
determining a plurality of motion vector differences (MVD), wherein each motion vector difference is based on a difference between the corresponding MVP and the CPMV for each control point; and
coding the plurality of MVDs in the bitstream, in response to the bilinear model being used; and
storing the bitstream in a non-transitory computer-readable medium.

17. The method of claim 16, wherein the coded information comprises:
a bilinear model flag for indicating whether the bilinear model is used, or a model index for indicating which model is used.

18. The method of claim 16, wherein the coded information comprises:
a difference between a corresponding MVD and a corresponding MVP associated with a corresponding CPMV.

19. The method of claim 16, the generating of the bitstream further comprising:
using the bilinear model in a merge mode by constructing a bilinear merge candidate using a combination of the plurality of CPMVs.

20. The method of claim 16, wherein the bilinear model comprises a plurality of linear parameters and a plurality of non-linear parameters, and a base motion vector (MV).
